(19) United States
(12) Patent Application Publication
(10) Pub. No.: US 2005/0004272 A1
(43) Pub. Date: Jan. 6, 2005

(54) Small-particle latex compositions based on waterborne alkyd seeds

(76) Inventors: Thauming Kuo, Kingsport, TN (US); Daphne Luecindy Christine Eggers, Watauga, TN (US); Mark Dwight Clark, Kingsport, TN (US)

Correspondence Address: Michael K. Carrier;Eastman Chemical Company, P.O. Box 511, Kingsport, TN, 37662-5075, US

(21) Appl. No.: 10/601,512

(22) Filed: Jun. 23, 2003

(51) Int. Cl. C08K 3/20

(52) U.S. Cl. 523/501

(57) ABSTRACT

Aqueous latex polymer dispersion compositions are disclosed characterized by their small particle size. The compositions are prepared by emulsion polymerization of one or more ethylenically unsaturated monomer in the presence of an alkyd seed containing sulfonate groups. Coatings based on these latex dispersions have improved advantages in film forming, gloss, hardness, low residual monomer content, less yellowing, and low VOC. The latex dispersions, having average particle sizes of 60-140 nm, are prepared by using a small ratio (i.e. about 2-15 wt. %) of an aqueous alkyd dispersion as the seed for latex particle growth. The waterborne alkyds are based on 5-sodiosulfo-isophthalic acid and either unsaturated or saturated fatty acids. The latex polymer dispersions thus obtained have improved film forming properties as well as low residual monomer content. The latexes are capable of forming clear, hard films at room temperature in the absence of external coalescents. Moreover, the resultant films are essentially non-yellowing. Thus, the latexes of this invention could be formulated into zero- or low-VOC paints for a variety of coating applications.

### FIELD OF THE INVENTION

The invention relates to aqueous latex polymer dispersion compositions having a small particle size, and more specifically, to those prepared by emulsion polymerization of ethylenically unsaturated monomers using an alkyd containing sulfonate groups as a seed. The advantages of coatings based on these dispersions include improvements in film forming behavior, gloss, hardness, and low residual monomer content, reduced yellowing (when compared to other alkyd/acrylic hybrids having >20% alkyd content), and lower volatile organic content (VOC).

### BACKGROUND OF THE INVENTION

Increasingly stringent VOC regulations have encouraged the coating industry to explore novel technologies to reduce solvent emissions from coating types, including architectural, automotive, and industrial maintenance. Waterborne coatings are of particular interest since they are environmentally friendly and can be conveniently applied to a substrate in the same manner as solvent-based coatings.

Alkyd emulsions and acrylic latexes are the two most common waterborne technologies used in the coating industry. Coatings based on alkyd emulsions exhibit advantages over those based on latexes in terms of gloss, brush-ability, open time, flow & leveling, hiding per coat, mar resistance, sand-ability, and adhesion. Advantages of acrylic latexes over alkyd emulsions include quick drying, durability, non-yellowing, non-embrittling, and non-chalking. It would clearly be an advance in the art to obtain an ideal balance of the best properties of each of the two coating types.

In addition to the advantages described above for alkyds, coatings based on alkyd-modified latexes have improved film forming properties due to the presence of alkyd moieties, which typically have a low glass transition temperature (Tg). However, the incorporation of the alkyd has also resulted in critical problems, such as soft films (causing dirt pick-up and poor block resistance), high residual monomer content (caused by incomplete emulsion polymerization due to chain transfer to unsaturated groups), and yellowing. Thus, there remains a need for an alkyd-modified latex that has a low residual monomer content, less yellowing, and the ability to form a hard film.

Alkyd emulsions are commonly prepared by a sophisticated emulsification process using a surfactant and a homogenizer. The process is often carried out under elevated temperature and pressure. Alkyds prepared by co-polymerizing a sulfomonomer such as 5-sodiosulfoisophthalic acid (SSIPA) offer an alternative to the preparation of waterborne alkyds. Such alkyds can be conveniently dispersed in water, and are disclosed, for example, in U.S. Pat. Nos. 5,378,757 and 5,530,059.

U.S. Pat. No. 5,277,978 discloses a process of producing a stable polymer dispersion by aqueous emulsion polymerization of an ethylenically unsaturated monomer in the presence of a stabilizer selected from a polyester or polyamide containing a sulfate or sulfonate group. The polyester or polyamide is obtained by condensation of a dicarboxylic acid, its anhydride, or its ester, with a diol or a diamine, and has an average molecular weight of about 2,000 to about 100,000.

U.S. Pat. No. 6,001,922 discloses the preparation of small particle size polyester/acrylic hybrid latexes via a two-stage emulsion polymerization process. In this process, the more hydrophilic acrylic monomers are polymerized in the first stage, in the presence of a water-dispersible polyester or polyester-amide, to yield a relatively hydrophilic first stage. A subsequent addition of hydrophobic monomers to the latex “seed” formed in the first stage results in an inversion of the latex such that the more hydrophilic first stage is at the particle surface.

The two references just discussed teach the preparation of polyester/acrylic hybrid latexes in the presence of linear polyesters. These polyesters differ from alkyd polymers because they do not contain a fatty acid or ester, or a naturally occurring oil, in the polymer compositions. Thus, they typically have a higher molecular weight, a higher Tg, and less hydrophobic character, all of which are disadvantages in terms of obtaining improved latex film-forming.

The next two references relate to the preparation of alkyd/latex hybrid polymer dispersions.

PCT WO 95/02019 discloses hybrid emulsions comprising an air-drying alkyd resin, combined with an acrylate resin, dispersed in water. The alkyd resin is said to have an oil length between about 0% and about 90%, and has attached ionic groups which are salts of acidic groups having a pKa of less than about 3. The document exemplifies preparing hybrid emulsions having a 50:50 ratio of alkyd/acrylic, by first mixing an alkyd emulsion having a particle size ranging from 152 nm to 488 nm with an acrylic monomer to yield a pre-emulsion. The pre-emulsion is then further emulsified in high-pressure emulsifying equipment. The resulting pre-emulsion of the alkyd/acrylic mixture is then heated to 80° C., and an initiator added for a batch emulsion polymerization process. The hybrid emulsions thus prepared have average particle sizes ranging from 176 nm to 540 nm.

U.S. Pat. No. 6,262,149 discloses a latent oxidatively-functional-modified alkyd comprising the product of at least one latent oxidatively-functional monomer polymerized in the presence of a waterborne alkyd having at least one pendant sulfonate functionality. The patent includes examples for the preparation of acrylic-modified sulfonated alkyd dispersions made by feeding the acrylic monomers to the alkyd dispersion during the course of emulsion polymerization. The alkyd content was in the range of 20-50%, and the resulting acrylic-modified alkyd dispersions had average particle sizes ranging from 146 nm to 371 nm.

The two references just described are directed to the preparation of alkyd/latex hybrid dispersions using alkyds in an amount of about 20-50 wt. %, with respect to the total dry weight of the latex and the alkyd. The reported particle sizes of these hybrid emulsions are seen to be relatively large, as was previously described. The references do not address preparing hybrid emulsions having small particle sizes, for example from about 60 to 140 nm. In fact, based on the data reported in these references, one skilled in the art would expect that latexes having particle sizes larger than the reported 200-500 nm would be obtained if a lower level (less than 20 wt. %) of the alkyd was used in the emulsion polymerization. This is because, if the SSIPA alkyds were to act as polymeric surfactants, it is well known in the art that the less surfactant used, all other things being equal, the larger would be the latex particle formed. And if the SSIPA alkyds were to act as seeds, then one would likewise expect that with fewer seeds used, each of the resulting particles would be larger.

Contrary to these expectations, we have discovered that when about 2-15 weight percent of a waterborne alkyd used as a seed is reacted with about 85-98 weight percent of one or more ethylenically unsaturated latex monomers, each of the amounts being based on the total solids weight of the alkyd and the latex, the latex dispersion particles obtained have an average particle size from about 60-140 nm. In another aspect, less than 10 weight percent of a waterborne alkyd is reacted with the corresponding weight percent latex monomer, to obtain latex dispersion particles having an average particle size from about 70 to about 130 nm, or from about 80 to about 110 nm.

This discovery is not merely of academic interest. A latex dispersion having a relatively small average particle size is highly desirable, since it has advantages in terms of gloss and film forming properties, film clarity, and porous-substrate penetration. The dispersion according to the claimed invention provides an alkyd/acrylic hybrid latex dispersion that has a relatively small particle size, a low residual monomer content, reduced yellowing, and low VOC, with the ability to form a hard film.

### BRIEF SUMMARY OF THE INVENTION

In one aspect, the invention relates to aqueous latex dispersions, having an average particle size from about 60-140 nm, produced via emulsion polymerization using from 2-15 wt. %, based on the total weight of the alkyd and the latex, of a sulfonated waterborne alkyd as seed. The seed is reacted with at least one ethylenically unsaturated monomer, as is known to those skilled in the art of latex emulsion polymerization.

In another aspect, the invention relates to an aqueous latex dispersion composition having an average particle size from about 60-140 nm, comprising the emulsion polymerization reaction product of:
(a) from about 2-15 weight percent, based on the total solids weight of (a) and (b), of a waterborne alkyd comprising the polycondensation reaction products of
   i. from about 10 to 50 weight percent of a glycol and/or polyol,
   ii. from about 10 to 80 weight percent of a monobasic fatty acid or fatty ester, a naturally occurring oil, or a partially saponified oil,
   iii. from about 5 to 40 weight percent of a di- and/or poly-carboxylic acid or anhydride, and
   iv. from about 5 to 15 weight percent of a sulfomonomer or sulfomonomer adduct containing at least one sulfomonomer group, wherein the weight percent is based on the weight of sulfomonomer or sulfomonomer group;
      wherein the weight percents of (i), (ii), (iii), and (iv) are based on the total weight of (i), (ii), (iii), and (iv);
(b) about 85-98 weight percent, based on the total solids weight of (a) and (b), of one or more ethylenically unsaturated monomers; and
(c) a catalytic amount of an initiator for free-radical emulsion polymerization;
   wherein components (b) and (c) are fed into an aqueous dispersion of (a) during the emulsion polymerization process, preferably continuously.

In addition to having small particle sizes, the latex polymer dispersions thus obtained have improved film forming properties as well as a low residual monomer content. The latexes are capable of forming clear, hard films at room temperature, in the absence of external coalescents. Moreover, the resultant films are essentially non-yellowing. Thus, they may be formulated into zero- or low-VOC paints for gloss and semi-gloss coating applications.

### DETAILED DESCRIPTION OF THE INVENTION

The Applicants have unexpectedly discovered that waterborne latex dispersions having small average particle sizes (e.g. less than 140 nm) can be prepared by emulsion polymerization of ethylenically unsaturated monomers, in the presence of a small amount (from about 2-15 wt. %, or from 5-10 wt. %) of an alkyd containing sulfonate groups. The formation of small latex particles is achieved by using an aqueous dispersion of the alkyd having an average particle size of about 15-50 nm, or from about 20-40 nm, as the basis, or seed, for latex particle growth.

In addition to having a small particle size, the latex polymer dispersions thus obtained have improved film forming properties and a low residual monomer content. The latexes are capable of forming clear, hard films at room temperature in the absence of external coalescents. Moreover, the resultant films are essentially non-yellowing. The latex dispersions of this invention may be synthesized without the addition of surfactants commonly used as stabilizers for emulsion polymerization. This is advantageous for coating applications having improved water resistance.

Thus, in one aspect the present invention provides an aqueous latex dispersion composition, comprising the emulsion polymerization reaction product of:
(a) about 2 to about 15 weight percent, based on the total weight of (a) and (b), of a sulfonated alkyd;
(b) about 85 to about 98 weight percent, based on the total weight of (a) and (b), of one or more ethylenically unsaturated monomers; and
(c) a catalytic amount of an initiator for free-radical emulsion polymerization,
wherein components (b) and (c) are fed into an aqueous dispersion of (a) during the emulsion polymerization process.

The sulfonated alkyd of the invention can comprise the polycondensation reaction product of:
i. about 10 to about 50 weight percent of one or more of: a glycol or a polyol,
ii. about 10 to about 80 weight percent of one or more of: a monobasic fatty acid, a monobasic fatty ester, a naturally occurring oil, or a partially-saponified oil,
iii. about 5 to about 40 weight percent of one or more of: a dicarboxylic acid or anhydride or a poly-carboxylic acid or anhydride, and
iv. about 5 to about 15 weight percent of one or more of: a sulfomonomer or a sulfomonomer adduct containing at least one sulfomonomer group, wherein the weight percent is based on the weight of the sulfomonomer,
wherein the weight percents of (i), (ii), (iii), and (iv) are based on the total weight of (i), (ii), (iii), and (iv).

In another embodiment, an aqueous latex dispersion composition of the invention has an average particle size from about 60-140 nm, and comprises the emulsion polymerization reaction products of:
(a) from about 2-15 weight percent, based on the total solids weight of (a) and (b), of a waterborne alkyd comprising the polycondensation reaction products of
   i. from about 10 to about 50 weight percent of a glycol and/or polyol,
   ii. from about 10 to about 80 weight percent of a monobasic fatty acid or fatty ester, a naturally occurring oil, or a partially saponified oil,
   iii. from about 5 to about 40 weight percent of a di- and/or poly-carboxylic acid or anhydride, and
   iv. from about 5 to about 15 weight percent of a sulfomonomer or sulfomonomer adduct containing at least one sulfomonomer group, wherein the weight percent is based on the weight of sulfomonomer or sulfomonomer group;
   wherein the weight percents of (i), (ii), (iii), and (iv) are based on the total weight of (i), (ii), (iii), and (iv);
(b) about 85-98 weight percent, based on the total solids weight of (a) and (b), of one or more ethylenically unsaturated monomers; and
(c) a catalytic amount of an initiator for free-radical emulsion polymerization;
wherein components (b) and (c) are fed into an aqueous dispersion of (a) during the emulsion polymerization process, preferably continuously.

The term “average particle size” or “particle size” used in this disclosure refers to the most common particle size indicator: the maximum of a particle size distribution (or volume mode diameter), as measured by a PL-PSDA particle size distribution analyzer available from Polymer Laboratories (Amherst, Mass.), as further discussed below. Additionally, the particle size refers to the maximum or the major peak, which may or may not be the only peak present in the particle size distribution. The presence of more than one peak is commonly referred to as bimode- or multimode-particle size distribution. It is preferred that the major peak represent at least 70% of the total particle size distribution.

In other aspects, the percentage of (a) is from about 3-10% and (b) about 97-90%; or the percentage of (a) is 5-8% and (b) is 95-92%. The solid content of the aqueous latex dispersion is about 25-60 weight %; or about 35-55%, or about 40-50%.

The fatty acid, fatty ester, or oil of component (ii) used to synthesize the waterborne alkyd may be either unsaturated, saturated, or a mixture thereof.

The component (a) may be prepared by contacting the reactants (i), (ii), (iii), (iv), and optionally a catalytic amount of an acid catalyst, in a reactor equipped with a stirrer, a steam-jacketed partial condenser, a Dean-Stark trap, a water condenser, and a nitrogen inlet. The temperature is then gradually raised to 200-240° C. and water collected. The reaction is allowed to continue until the desired acid number (e.g. 5-20 mgKOH/g) is obtained. The resulting alkyd may be isolated neat or as an aqueous dispersion having 30-70% solids. The dispersion can be prepared by gradually adding a suitable amount of water to the reactor at about 60-90° C., or by adding the hot alkyd (e.g. 80-200° C.) to warm water (e.g. 60-80° C.) in a separate container

In addition to the above method, a preferred process for making the SSIPA alkyd is a two-stage method, wherein an NPG/SIP adduct is prepared by reacting neopentyl glycol (NPG) and SSIPA at the first stage, or as a master batch in a separate reactor. A description of the method for the preparation of the NPG/SIP adduct may be found, for example, in

U.S. Pat. No. 6,444,781, the disclosure of which is incorporated herein by reference in its entirety. The NPG/SIP adduct thus prepared may be insolated neat or as a 90% solids in water. The adduct is then used as a reactant for the resin synthesis together with components (i), (ii), and (iii) according to the one-stage process described above. The amounts of NPG (a diol) and SSIPA (a sulfomonomer) required for preparing the NPG/SIP adduct must be taken into account as part of the components (i) and (iv) in the above alkyd composition.

The aqueous latex polymer dispersion of the present invention is prepared by mixing the alkyd of component (a) or its aqueous dispersion (30-70% solids) with a suitable amount of water in a reactor equipped with an agitation device to yield a dilute alkyd dispersion. The reaction mixture is then heated to a temperature suitable for free radical emulsion polymerization (e.g. about 70-90° C. for the ones using thermo initiators and about 55-65° C. for redox initiators). To the stirred alkyd dispersion are fed simultaneously a solution of an initiator (c) and a mixture of the neat ethylenically unsaturated monomers (b) during a period of 2-4 hours. After the additions, a small amount of an additional initiator, preferably a redox system, is subsequently added as a “chaser” to reduce the residual monomer content. The ‘chaser’ step is typically carried out at 40-60° C. for 30-60 min. It is desirable to have less than 500 ppm of unreacted monomers in the final latex product.

Thus, another aspect of the present invention is a process for preparing an aqueous latex dispersion, comprising the steps of:
preparing an aqueous dispersion of a sulfonated alkyd to form seed particles; and
polymerizing one or more ethylenically unsaturated monomers, in the presence of the sulfonated alkyd resin seed particles, to obtain an aqueous latex dispersion,
wherein the sulfonated alkyd resin is provided in an amount from about 2-15 wt. %, based on the total weight of the sulfonated alkyd resin and the one or more ethylenically unsaturated monomer. In a further aspect, the invention relates to a free-radical emulsion polymerization process for the preparation of aqueous latex dispersions, comprising the steps of:
I. mixing the component (a) with water in a reactor to yield a dilute alkyd dispersion,
II. raising the temperature of the reaction mixture to about 70-90° C., for the reaction using thermo initiators, or to about 55-65° C., for the reaction using redox initiators,
III. feeding simultaneously a solution of an initiator (c) and a mixture of the ethylenically unsaturated monomers (b) over a period of 2-4 hours, and
IV. optionally, adding an additional amount of an initiator and allowing the reaction to continue for another 30-60 min. to ensure the completion of the reaction.

In the above processes, an additional amount of the initiator (the kicker) is often added to the reaction mixture before the start of step III, to initiate the emulsion polymerization process more effectively. Further, a base (buffer) such as ammonium carbonate, sodium hydroxide, or sodium carbonate, is often added to the initiator feed solution in order to adjust the pH of the reaction mixture during emulsion polymerization.

A monomer pre-emulsion may be used to replace the neat monomer mixture in step III. The monomer pre-emulsion is prepared by mixing component (b) with a surfactant in water. Suitable surfactants include DISPONIL FES 993 (sodium lauryl ether sulfate, available from Cognis Corp. Ambler, Pa.), AEROSOL TR 70 (sodium bistridecyl sulfosuccinate, available from CYTEC Industries, West Paterson, N.J.), and HITENOL BC-1025 (polyoxyethylene alkylphenyl ether ammonium sulfate, available from Montello Inc, Tulsa, Okla.).

A two-stage monomer feed may also be used to afford a latex having “core-shell” structure, as is commonly practiced in the art, wherein two monomer-feeds are carried out sequentially. The two monomer feeds are typically designed as a hard phase (high Tg) and a soft phase (low Tg). These two monomer feeds may also be carried out by a “power feed” method, wherein the second monomer feed is added to the first monomer feed, preferably continuously, while the resulting mixture in the first monomer feed is simultaneously added to the reactor to yield a latex having a gradient polymer composition. The term “gradient polymer composition” refers to the fact that, in the power feed method, the monomer feed composition is continuously changing, which leads to polymer molecules containing increasingly higher ratios of monomers from the second monomer feed, over time.

Typical initiators (thermo or redox) include hydrogen peroxide, potassium or ammonium peroxydisulfate, dibenzoyl peroxide, lauryl peroxide, ditertiary butyl peroxide, 2,2′-azobisisobutyronitrile, t-butyl hydroperoxide, benzoyl peroxide, and the like.

When the above initiators are used for the redox system; they are used in combination with a reducing agent and optionally a catalyst.

Suitable reducing agents are those which increase the rate of polymerization and include for example, sodium bisulfite, sodium metabisulfite, sodium formaldehyde sulfoxylate, ascorbic acid, isoascorbic acid, and mixtures thereof.

Suitable catalysts are those compounds that increase the rate of polymerization and that, in combination with the above described reducing agents, promote decomposition of the polymerization initiator under the reaction conditions.

Suitable catalysts include transition metal compounds such as, for example, ammonium iron (II) sulfate hexahydrate, ferrous chloride, cupric sulfate, cupric chloride, cobalt acetate, cobaltous sulfate, and mixtures thereof.

The particle sizes of the aqueous latex dispersions of the present invention can be controlled by adjusting the alkyd ratio—the higher the alkyd ratio, the smaller the latex particle. The average particle size of the alkyd dispersion employed as a seed for emulsion polymerization is about 15-50 nm, and the resulting latex is about 60-140 nm.

The latexes are capable of forming clear, hard films at room temperature in the absence of common coalescents such as ether alcohols and ester alcohols.

A particle size distribution analyzer, model PL-PSDA available from Polymer Laboratories (Amherst, Mass.), was used for the measurements described in the present application, unless otherwise indicated, though other methods of measurement are known to those skilled in the art, as further discussed below. The PL-PSDA Operating Manual, supplied by Polymer Laboratories Ltd, Essex Road, Church Stretton, Shropshire SY6 6AX, UK, is incorporated herein by reference in its entirety.

In the particle size determinations based on PL-PSDA set out in the present application, the particle size was measured by hydrodynamic fractionation chromatography using a Polymer Labs PSDA analyzer equipped with a 20-2000 nm column, a flow rate of 2 ml/min, a mobile phase of Polymer Labs proprietary eluent and UV detection at 254 nm. Nitrobenzene sulfonic acid was used as a flow marker. Samples were prepared by dispersing 20 mg of latex in 10 ml of the proprietary eluent and filtering through a 21 m filter. A 20 μl sample of the resulting solution was injected into the column. The particle size distribution was calculated from the resulting chromatogram using Polymer Labs proprietary software. The instrument was calibrated against 22, 50, 102, 343, 512, 701 and 993 nm Duke PS particle size standards.

In hydrodynamic fractionation chromatography, the retention time is a function of the hydrodynamic volume that, in the case of spherical particles, is proportional to the diameter of the particle. The relationship between retention time and particle size is calibrated by measuring a series of Duke particle size standards. Since the instrument is calibrated to external particle size standards, and the samples are run under the same experimental conditions as the standards, the measured particle size distribution is independent of such things as flow rate, column type, etc. The size calibration is performed by fitting a quadratic equation, d(t), to the retention times of the standards.

The column broadening is calibrated by fitting a split Pearson-7 peak to each of the Duke standards. The resulting peak widths are then fit to a quadratic equation to give the broadening as a function of particle size, w(t). Knowing d(t) and w(t), the particle size distribution can be calculated by deconvoluting the equation:
c(t)=∫p(t)d(t)w(t)dt
where c(t)=measured chromatogram and p(t)=differential volume particle size distribution.

The calculated particle size distribution is the differential volume particle size distribution or:

$$\frac{ⅆ V}{ⅆ r}$$

vs. r where r=particle diameter.

The software allows the user to select the maximum and minimum particle diameter to be used in the calculation, or to let the software select the diameter range. If a diameter range is selected so that a “significant portion of the chromatogram” is not used in the deconvolution, the resulting particle size distribution will be affected. “Significant portion of the chromatogram”means a portion of the chromatogram in which particles were detected above baseline. Therefore, in all cases, the maximum and the minimum diameters are selected so that all significant parts of the chromatogram are used in the calculation.

For multimodal distributions, defined as distributions with a local minimum in the distribution, the proprietary software divides the particle size distribution into modes. The volume mode diameter or average diameter of each mode is calculated as the maximum of the dv/dr distribution within a particular mode. The shape of the mode is not relevant for this parameter.

Another method of particle size determination is based on dynamic light scattering. This method is used by Microtrac UPA 150 and UPA 350, for example, both available from Microtrac, Inc. (Montgomeryville, Pa.). In the examples of the present application, a Microtrac UPA 150 was also used to measure several samples, to compare the results obtained from PL-PSDA. In general, particle sizes smaller than 50 nm were not detected by Microtrac UPA 150, and there were also some differences in results between the two methods. For example, the latex prepared in example 4 showed 107 nm by PSDS and 115 nm by Microtrac, and that of example 13 showed 96 nm by PSDA and 86 nm by Microtrac. These variances in particle size measurement techniques are known in the art. It is generally understood that such particle size determinations are not absolute, and that a reasonable margin of error would be considered ±5 depending on the equipment used, and the size of the polymer particles tested.

Thus, in the aqueous latex dispersion compositions of the invention, the aqueous latex dispersion generally exists as particles dispersed in water. The particles are generally spherical in shape. The particles may be structured or unstructured. Structured particles include, but are not limited to, core/shell particles and gradient particles. The core/shell polymer particles may also be prepared in a multilobe form, a peanut shell, an acorn form, or a raspberry form. It is further preferred in such particles that the core portion comprises about 20 to about 80 wt % of the total weight of the particle and the shell portion comprises about 80 to about 20 wt % of the total weight of the particle.

The average particle size of the aqueous latex dispersion may range from about 60 to about 140 nm, or from about 70 to about 110 nm, or less than 140 nm, or less than 110 nm. The particles generally have a spherical shape.

The glass transition temperature (Tg) of the acrylic portion of the hybrid resin in accordance with the invention may be up to about 100° C. In a preferred embodiment of the invention, where film formation at ambient temperatures is desirable, the glass transition temperature may preferably be under about 70° C., or from about 0-60° C.

The aqueous latex dispersions of the invention are prepared by polymerization of at least one ethylenically unsaturated monomer using the sulfonated waterborne alkyd as a seed particle. An emulsion polymerization process is used according to the invention, since emulsion polymerization allows for the preparation of high molecular weight polymers at low viscosity. The polymerization may take place as a single stage or a multi-stage feed.

Sulfonated Waterborne Alkyd Resin

A sulfonated waterborne alkyd resin for use in the water-based latex dispersion of the invention may be any waterborne alkyd resin having at least one pendant sulfonate functionality known in the art, including any water-dissipatible, water-dispersible, or water-reducible (i.e. able to be dispersed into water) alkyd resin. Examples of such alkyd resins are described in U.S. Pat. Nos. 5,378,757 and 5,530,059, both of which are incorporated herein by reference.

Generally, sulfonated waterborne alkyd resins may be prepared by reacting a monobasic fatty acid or fatty ester, or a naturally occurring, partially-saponified oil; a glycol or polyol; a polycarboxylic acid; and a sulfomonomer or sulfomonomer adduct containing at least one sulfomonomer group.

The monobasic fatty acid, fatty ester, or naturally occurring, partially saponified oil is preferably selected from the formulae (I), (II), and (III):

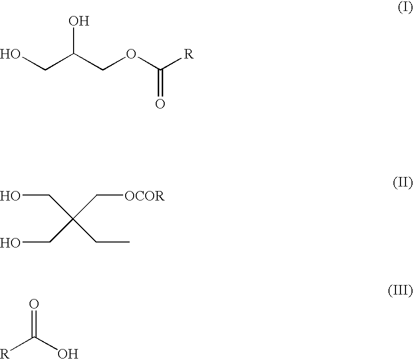

In formulae (I), (II) and (III), R is a saturated or unsaturated C₈-C₂₀ alkyl group. More particularly, R is one of the following unsaturated C₁₇ alkyl groups:

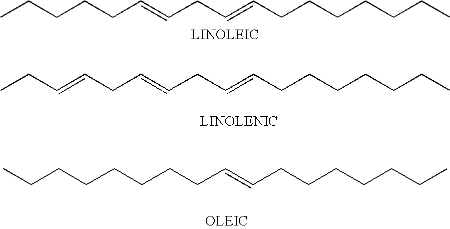

The monobasic fatty acid or fatty ester, or the naturally occurring, partially-saponified oil, can be prepared by reacting a fatty acid or oil with a polyol. Examples of suitable oils include, but are not limited to, sunflower oil, canola oil, dehydrated castor oil, coconut oil, corn oil, cottonseed oil, fish oil, linseed oil, oiticica oil, soya oil, and tung oil, animal grease, castor oil, lard, palm kernel oil, peanut oil, perilla oil, safflower oil, tallow oil, walnut oil, and the like. Suitable examples of fatty acids alone or as components of oil include, but are not limited to, tallow acid, soya acid, myristic acid, linseed acid, crotonic acid, versatic acid, coconut acid, tall oil fatty acid, rosin acid, neodecanoic acid, neopentanoic acid, isostearic acid, 12-hydroxystearic acid, cottonseed acid, and the like.

The glycol or polyol is preferably selected from aliphatic, alicyclic, and aryl alkyl glycols. Suitable examples of glycols include, but are not limited to, ethylene glycol, propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, 1,3-propanediol, 2,4-dimethyl-2-ethyl-hexane-1,3-diol, 2,2-dimethyl-1,3-propanediol, 2-ethyl-2-butyl-1,3-propanediol, 2-ethyl-2-isobutyl-1,3-propanediol, 1,3-butanediol, 1,4-butanediol, 1,5-pentanediol, 1,6-hexanediol, 2,2,4-tetra methyl-1,6-hexanediol, thiodiethanol, 1,2-cyclohexanedimethanol, 1,3-cyclohexanedimethanol, 1,4-cyclohexanedimethanol, 2,2,4-trimethyl-1,3-pentanediol, 2,2,4-tetramethyl-1,3-cyclobutanediol, p-xylenediol, hydroxypivalyl hydroxypivalate, 1,10-decanediol, hydrogenated bisphenol A, and the like.

Suitable examples of polyols include, but are not limited to, trimethylolpropane (TMP), pentaerythritol (PE), trimethylolethane, erythritol, threitol, dipentaerythritol, sorbitol, glycerine, and the like. Preferably, the polyol is trimethylolpropane (TMP) or pentaerythritol (PE).

The polyacid (dicarboxylic acid or tricarboxylic acid) and monofunctional acid (monocarboxylic acid) components of the alkyd resin may be any polyacid or monofunctional acid known in the art used in the formation of an alkyd resin. The dicarboxylic acid may be, for example, isophthalic acid, phthalic anhydride or acid, terephthalic acid, adipic acid, tetrachlorophthalic anhydride, dodecanedioic acid, sebacic acid, azelaic acid, 1,4-cyclohexanedicarboxylic acid, 1,3-cyclohexanedicarboxylic acid, hexahydrophthalic anhydride, tetrahydrophthalic anhydride, maleic anhydride, fumaric acid, succinic anhydride, succinic acid, 2,6-naphthalenedicarboxylic acid, glutaric acid, and the like. Preferably, the dicarboxylic acid is isophthalic acid, phthalic anhydride, or phthalic acid. The tricarboxylic acid may be, for example, trimellitic anhydride. A monofunctional acid may also be used such as benzoic acid, acetic acid, propionic acid, t-butylbenzoic acid, and butanoic acid.

The sulfomonomer of the sulfomonomer adduct is either a difunctional or a monofunctional monomer containing a —SO₃M group attached to an aromatic nucleus where M is hydrogen or a metal ion such as, for example, Na⁺, Li⁺, K⁺, Ca²⁺, Cu²⁺, Fe₂₊, or Fe₃₊. The sulfomonomer as a difunctional monomer component may be a dicarboxylic acid (or a derivative thereof) containing a —SO₃M group where M is as defined above. Suitable examples of the aromatic nucleus to which the —SO₃M group may be attached include, but are not limited to, benzene, naphthalene, anthracene, diphenyl, oxydiphenyl, sulfonyl-diphenyl, and methylenediphenyl.

Especially good results are obtained when the difunctional monomer is a sodium salt of a sulfoisophthalic acid, a sulfoterephthalic acid, a sulfophthalic acid, a 4-sulfo-naphthalene-2,7-dicarboxylic acid or a derivative thereof. More preferably, the difunctional monomer is 5-sodiosulfoisophthalic acid or a derivative such as dimethyl 5-sodiosulfoisophthalate. Other preferred difunctional monomers are lithium 5-sulfoisophthalic acid, dimethyl lithium 5-sulfoisophthalate, potassium 5-sulfoisophthalic acid, and dimethyl potassium 5-sulfoisophthalate.

Other effective difunctional monomers containing a —SO₃M group attached to an aromatic nucleus include metal salts of aromatic sulfonic acids or their respective esters of the formula IV: 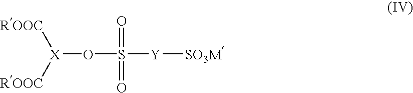
wherein X is a trivalent aromatic hydrocarbon radical, Y is a divalent aromatic hydrocarbon radical, R′ is hydrogen or an alkyl group of one to four carbon atoms, M′ is hydrogen Na⁺, Li⁺, or K⁺. Examples of preferred monomers of formula (IV) include, but are not limited to, 4-sodiosulfophenyl-3,5-dicarbomethoxybenzenesulfonate, 4-lithiosulfophenyl-3,5-dicarbomethoxybenzenesulfonate and 6-sodiosulfo-2-naphthyl-3,5-dicarbomethoxybenzenesulfonate.

Still other effective difunctional monomers containing a —SO₃M group attached to an aromatic nucleus include metal salts of sulfodiphenyl ether dicarboxylic acids or esters thereof of the formula (V): 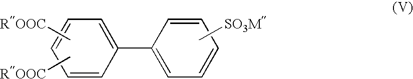
wherein R″ is hydrogen, an alkyl group of one to eight carbon atoms, or phenyl and M″ is hydrogen, K⁺, Na⁺, or Li⁺. Examples of preferred monomers include, but are not limited to, dimethyl 5-[4-(sodiosulfo)-phenoxy]isophthalate, dimethyl 5-[4-(sodiosulfo) phenoxy]terephthalate, and 5-[4-(sodiosulfo)phenoxy]isophthalic acid. Additional examples of such monomers are disclosed in U.S. Pat. No. 3,734,874, incorporated herein by reference.

The type and amount of metal sulfonate selected for water dispersability can be varied to obtain useful ion-containing alkyd resins. As little as 2 weight percent, based on the total weight of the reactants of the alkyd composition, will impart a significant degree of water miscibility; however, at least 3 percent is preferred. Water-soluble alkyds can be formulated with as much as 20 weight percent of the metal sulfonate. However, a practical upper limit to counteract the water sensitivity effects is 15 percent, preferably 10 percent.

Metal sulfonates that are preferred include 5-sodiosulfoisophthalic acid, dimethyl 5-sodiosulfoisophthalate, lithium 5-sulfoisophthalic acid, dimethyl lithium 5-sulfoisophthalate, potassium 5-sulfoisophthalic acid, dimethyl potassium 5-sulfoisophthalate, 3-sodiosulfobenzoic acid, and the like.

Optionally, the sulfomonomer containing at least one sulfonate group that may be reacted with a polyol to produce a polyol (e.g. a diol) sulfomonomer adduct may be a monofunctional sulfomonomer containing at least one sulfonate group that may be reacted with a polyol containing at least three hydroxyl groups. The monofunctional sulfomonomer is preferably selected from the following group of sulfomonomers: 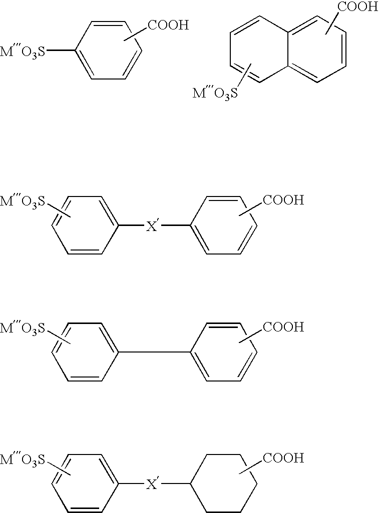
where X′ is CH₂, SO₂, or O and M′″ is an alkaline or alkaline earth metal.

When the polyol sulfomonomer adduct is prepared by reacting a difunctional sulfomonomer with a polyol, the polyol is preferably a diol. Suitable examples of diols include those described above with the following diols being some of the preferred: ethylene glycol, diethylene glycol, 2,2,4-trimethyl-1,3-pentanediol, 1,4-cyclohexanedimethanol, 1,3-cyclohexanedimethanol, hydroxypivalyl hydroxypivalate, dipropylene glycol, 1,6-hexanediol, 1,10-decanediol, 1,3-butanediol, hydrogenated bisphenol A, 1,4-butanediol and neopentyl glycol.

In addition to the amount of polyol reacted with the fatty acid or fatty ester, or the naturally occurring, or partially saponified oil according to the preferred step, and in addition to the polyol used in the preparation of the sulfomonomer adduct from a monofunctional sulfomonomer, an additional amount of a polyol or other branching agent such as a polycarboxylic acid may be used to increase the molecular weight and branching of the waterborne alkyd resin. These branching agents are preferably selected from trimethylolethane, pentaerythritol, erythritol, threitol, dipentaerythritol, sorbitol, glycerine, trimellitic anhydride, pyromellitic dianhydride, dimethylolpropionic acid, and trimethylolpropane.

In order for the alkyd resin to serve as a reactive filming aid (via oxidative coupling) in a hybrid latex and become incorporated into the crosslinked polymer film, it is preferred that the alkyd have some finite oil length—long, medium or short. The finite oil length or oil content is generally between about 20 wt % and about 90 wt % in the alkyd composition based on the total weight of the alkyd resin. A “long” oil alkyd has an oil length or oil content of about 60-90 wt % based on the total weight of the alkyd resin. A “medium” oil alkyd has an oil content of about 40-60 wt % based on the total weight of the alkyd resin. A “short” oil alkyd has an oil length or oil content of about 20-40 wt % based on the total weight of the alkyd resin.

Ethylenically Unsaturated Monomer

The acrylic portion of the water-based latex dispersion may be prepared by free radical polymerization of at least one ethylenically unsaturated monomer using a sulfonated waterborne alkyd as seed, as described above. Suitable ethylenically unsaturated monomers that may be used to prepare the latex polymer include, but are not limited to, one or more of acetoacetoxy ethyl methacrylate, acetoacetoxy ethyl acrylate, methyl acrylate, methyl methacrylate, ethyl acrylate, ethyl methacrylate, butyl acrylate, butyl methacrylate, isobutyl acrylate, isobutyl methacrylate, ethylhexyl acrylate, 2-ethylhexyl methacrylate, 2-ethyl hexyl acrylate, isoprene, octyl acrylate, octyl methacrylate, iso-octyl acrylate, iso-octyl methacrylate, trimethyolpropyl triacrylate, styrene, α-methyl styrene, vinyl naphthalene, vinyl toluene, chloromethyl styrene, glycidyl methacrylate, carbodiimide methacrylate, C₁-C₁₈ alkyl crotonates, di-n-butyl maleate, a or -β-vinyl naphthalene, di-octylmaleate, allyl methacrylate, di-allyl maleate, di-allylmalonate, methyoxybutenyl methacrylate, isobornyl methacrylate, hydroxybutenyl methacrylate, hydroxyethyl(meth)acrylate, hydroxypropyl(meth)acrylate, acrylonitrile, vinyl chloride, vinylidene chloride, vinyl acetate, vinyl ethylene carbonate, epoxy butene, 3,4-dihydroxybutene, hydroxyethyl(meth)acrylate, methacrylamide, acrylamide, butyl acrylamide, ethyl acrylamide, diacetoneacrylamide, butadiene, vinyl ester monomers, vinyl(meth)acrylates, isopropenyl(meth)acrylate, cycloaliphaticepoxy(meth)acrylates, ethylformamide, 4-vinyl-1,3-dioxolan-2-one, 2,2-dimethyl-4 vinyl-1,3-dioxolane, 3,4-di-acetoxy-1-butene, acrylic acid, methacrylic acid, itaconic acid, crotonic acid, and monovinyl adipate t-butylaminoethyl methacrylate, dimethylaminoethyl methacrylate, diethylaminoethyl methacrylate, N,N-dimethylaminopropyl methacrylamide, 2-t-butylaminoethyl methacrylate, N,N-dimethylaminoethyl acrylate, N-(2-methacryloyloxy-ethyl)ethylene urea, and methacrylamido-ethylethylene urea. Further monomers are described in The Brandon Associates, 2nd edition, 1992 Merrimack, N.H., and in Polymers and Monomers, the 1966-1997 Catalog from Polyscience, Inc., Warrington, Pa., U.S.A.

Water-Based Latexes

A water-based latex dispersion of the invention is prepared by polymerizing at least one ethylenically unsaturated monomer using as a seed an aqueous dispersion of a waterborne alkyd having at least one pendant sulfonate functionality.

The polymerization process by which the water-based latex dispersions are made may also require an initiator, a reducing agent, or a catalyst. Suitable initiators include conventional initiators such as ammonium persulfate, ammonium carbonate, hydrogen peroxide, t-butylhydroperoxide, ammonium or alkali sulfate, di-benzoyl peroxide, lauryl peroxide, di-tertiarybutylperoxide, 2,2′-azobisisobuteronitrile, benzoyl peroxide, and the like.

Suitable reducing agents are those which increase the rate of polymerization and include, for example, sodium bisulfite, sodium hydrosulfite, sodium formaldehyde sulfoxylate, ascorbic acid, isoascorbic acid, and mixtures thereof.

Suitable catalysts are those compounds which promote decomposition of the polymerization initiator under the polymerization reaction conditions thereby increasing the rate of polymerization. Suitable catalysts include transition metal compounds and driers. Examples of such catalysts include, but are not limited to, ferrous sulfate heptahydrate, ferrous chloride, cupric sulfate, cupric chloride, cobalt acetate, cobaltous sulfate, and mixtures thereof.

Optionally, a conventional surfactant or a combination of surfactants may be used as a costabilizer or cosurfactant, such as an anionic or non-ionic emulsifier, in the suspension or emulsion polymerization preparation of a hybrid latex of the invention. Examples of preferred surfactants include, but are not limited to, alkali or ammonium alkylsulfate, alkylsulfonic acid, or fatty acid, oxyethylated alkylphenol, or any combination of anionic or non-ionic surfactant. A more preferred surfactant monomer is HITENOL HS-20 (which is a polyoxyethylene alkylphenyl ether ammonium sulfate available from DKS International, Inc. of Japan). A list of suitable surfactants is available in the treatise: McCutcheon's Emulsifiers & Detergents, North American Edition and International Edition, MC Publishing Co., Glen Rock, N.J., 1993.

In general, the alkyd portion of the hybrid latex represents about 2-15 wt %, preferably about 3-12 wt %, or about 5-10 wt % of the total solids of the latex while the acrylic portion of the hybrid latex represents the corresponding remainders, being generally about 85-98 wt %, or about 88-97 wt %, or about 90-95 wt % of the total solids of the latex. Such hybrid latexes can be further used in coating compositions.

A coating composition of the invention contains the aqueous latex dispersion of the invention and may be prepared by techniques known in the art, for example as disclosed in any of U.S. Pat. Nos. 4,698,391, 4,737,551, and 3,345,313, each of which is incorporated herein by reference in its entirety. Examples of such coating compositions include, for example, architectural coatings, maintenance coatings, industrial coatings, automotive coatings, textile coatings, inks, adhesives, and coatings for paper, wood, and plastics. Coating compositions of the invention contain significantly less solvent, less than 25 wt % to as low as 1 wt %, or even zero VOC content. The waterborne alkyd portion of the hybrid resin retains the desirable properties of an alkyd while the acrylic portion of the resin improves the hardness and durability of the hybrid alkyd resin. The coating compositions of the invention produce coatings that have high gloss, fast cure, and good acid and caustic resistance.

The coating composition may be coated onto a substrate and cured using techniques known in the art (for example, by spray-applying 3 to 4 mils of wet coating onto a metal panel, and heating in a 150° C. forced air oven for 30 minutes). The substrate can be any common substrate such as wood, paper, polyester films such as polyethylene and polypropylene, metals such as aluminum and steel, glass, urethane elastomers, primed (painted) substrates, and the like. The coating composition of the invention may be cured at room temperature (ambient cure), at elevated temperatures (thermal cure), or may be photochemically cured.

A coating composition of the invention may further contain coating additives. Examples of such coating additives include, but are not limited to, one or more leveling, rheology, and flow control agents such as silicones, fluorocarbons or cellulosics; extenders; reactive coalescing aids such as those described in U.S. Pat. No. 5,349,026, incorporated herein by reference; plasticizers; flatting agents, pigment wetting and dispersing agents and surfactants; ultraviolet (UV) absorbers; UV light stabilizers; tinting pigments; colorants; defoaming and antifoaming agents; anti-settling, anti-sag and bodying agents; anti-skinning agents; anti-flooding and anti-floating agents; biocides, fungicides and mildewcides; corrosion inhibitors; thickening agents; or coalescing agents. Specific examples of such additives can be found in Raw Materials Index, published by the National Paint & Coatings Association, 1500 Rhode Island Avenue, N.W., Washington, D.C. 20005. Further examples of such additives and emulsion polymerization methodology may be found in U.S. Pat. No. 5,371,148, incorporated herein by reference.

Examples of flatting agents include, but are not limited to, synthetic silica, available from the Davison Chemical Division of W. R. Grace & Company under the SYLOID tradename; polypropylene, available from Hercules Inc. under the HERCOFLAT tradename; and synthetic silicate, available from J. M. Huber Corporation under the ZEOLEX tradename.

Examples of dispersing agents and surfactants include, but are not limited to, sodium bis(tridecyl)sulfosuccinnate, di(2-ethylhexyl)sodium sulfosuccinnate, sodium dihexylsulfosuccinnate, sodium dicyclohexyl sulfosuccinnate, diamyl sodium sulfosuccinnate, sodium diisobutyl sulfosuccinnate, disodium iso-decyl sulfosuccinnate, disodium ethoxylated alcohol half ester of sulfosuccinnic acid, disodium alkyl amido polyethoxy sulfosuccinnate, tetra-sodium N-(1,2-dicarboxyethyl)-N-octadecyl sulfosuccinnamate, disodium N-octasulfosuccinnamate, sulfated ethoxylated nonylphenol, 2-amino-2-methyl-1-propanol, and the like.

Examples of viscosity, suspension, and flow control agents include, but are not limited to, polyaminoamide phosphate, high molecular weight carboxylic acid salts of polyamine amides, and alkylene amine salts of an unsaturated fatty acid, all available from BYK Chemie U.S.A. under the ANTI TERRA tradename. Further examples include polysiloxane copolymers, polyacrylate solution, cellulose esters, hydroxyethyl cellulose, hydrophobically-modified hydroxyethyl cellulose, hydroxypropyl cellulose, polyamide wax, polyolefin wax, carboxymethyl cellulose, ammonium polyacrylate, sodium polyacrylate, hydroxypropyl methyl cellulose, ethyl hydroxyethyl cellulose, polyethylene oxide, guar gum and the like. Other examples of thickeners include the methylene/ethylene oxide associative thickeners and water soluble carboxylated thickeners such as, for example, UCAR POLYPHOBE by Union Carbide.

Several proprietary antifoaming agents are commercially available and include, for example, BUBREAK of Buckman Laboratories Inc., BYK (of BYK Chemie, U.S.A., FOAMASTER and NOPCO of Henkel Corp./Coating Chemicals, DREWPLUS of the Drew Industrial Division of Ashland Chemical Company, TRYSOL and TROYKYD of Troy Chemical Corporation, and SAG of Union Carbide Corporation.

Examples of fungicides, mildewcides, and biocides include, but are not limited to, 4,4-dimethyloxazolidine, 3,4,4-trimethyloxazolidine, modified barium metaborate, potassium N-hydroxy-methyl-N-methyldithiocarbamate, 2-(thiocyano-methylthio)benzothiazole, potassium dimethyl dithiocarbamate, adamantane, N-(trichloromethylthio)phthalimide, 2,4,5,6-tetrachloro-isophthalonitrile, orthophenyl phenol, 2,4,5-trichlorophenol, dehydroacetic acid, copper naphthenate, copper octoate, organic arsenic, tributyl tin oxide, zinc naphthenate, and copper 8-quinolinate.

Examples of U.V. absorbers and U.V. light stabilizers include among others substituted benzophenone, substituted benzotriazoles, hindered amines, and hindered benzoates, available from American Cyanamid Company under the CYASORB UV tradename, and diethyl-3-acetyl-4-hydroxy-benzyl-phosphonate, 4-dodecyloxy-2-hydroxy benzophenone, and resorcinol monobenzoate.

Examples of solvents and coalescing agents are well known and include, but are not limited to, ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol mono-isobutyrate, ethylene glycol mono-octyl ether, diacetone alcohol, TEXANOL® ester alcohol (Eastman Chemical Company), and the like. Such solvents and coalescing aids may also include reactive solvents and coalescing aids such as diallyl phthalate, SANTOLINK XI-100 (polyglycidyl allyl ether from Monsanto, and others as described in U.S. Pat. Nos. 5,349,026 and 5,371,148, incorporated herein by reference.

Pigments suitable for use in the coating compositions envisioned by the invention are the typical organic and inorganic pigments, well-known to one of ordinary skill in the art of surface coatings, especially those set forth by the Colour Index, 3d Ed., 2d Rev., 1982, published by the Society of Dyers and Colourists in association with the American Association of Textile Chemists and Colorists. Examples include, but are not limited to, the following: titanium dioxide, barytes, clay, or calcium carbonate, CI Pigment White 6 (titanium dioxide); CI Pigment Red 101 (red iron oxide); CI Pigment Yellow 42; CI Pigment Blue 15, 15:1, 15:2, 15:3, 15:4 (copper phthalocyanines); CI Pigment Red 49:1; and CI Pigment Red 57:1. Colorants such as phthalocyanine blue, molybdate orange, or carbon black are also suitable for the coating compositions of the invention.

With a proper combination of the alkyd ratio and the acrylic monomer Tg, the latex dispersions of this invention are capable of forming clear films when coated on a substrate, without the use of common coalescent aids or organic solvents. This is illustrated in the Examples section. All the latexes prepared in the examples (except examples 16 and 17) form clear, non-tacky films at room temperature in the absence of external coalescents. The resulting films also have excellent gloss and hardness, as described in the examples. Additionally, the latexes prepared all have a low residual monomer content (<500 ppm).

In a further aspect, the aqueous latex dispersion of the present invention may be formulated into a paint by adding a pigment such as TiO2 and one or more additives such as neutralizer, drier, defoamer, wetting and dispersing agent, rheology modifier, flow control agent, thickener, light or heat stabilizer, biocide, or corrosion inhibitor. Examples of suitable additives may be found in Handbook of Coatings Additives, ed. by L. J. Calbo; Marcel Dekker, Inc.; New York, N.Y.; 1987.

Such a paint may be prepared by first preparing a pigment grind using water, pigment, and a dispersing additive, alone or with other additives. The resulting pigment grind is then mixed with the latex dispersion, other additives, and optionally, more Water.

The present invention may be understood by reference to the foregoing detailed description of the invention, and by the Examples included herein.

This invention is not limited to specific synthetic methods, or to particular formulations, unless otherwise described and, as such, may vary from the description. The terminology used in the description is for the purpose of describing particular embodiments only, and is not intended to be limiting.

The singular forms a, an, and the include plural referents unless the context clearly dictates otherwise. Optional or optionally, as well as preferable and preferably, means that the subsequently described event or circumstances may or may not occur. The description includes instances where the event or circumstance occurs, and instances where it does not.

Ranges may be expressed herein as from about one particular value, and/or to about another particular value. When such a range is expressed, it is to be understood that another embodiment is from the one particular value and/or to the other particular value.

As used throughout the application, the units “phr” should be understood to mean parts per hundred of the ethylenically unsaturated monomers. Thus, for example, 5 phr of a SSIPA alkyd used as seed is equivalent to an alkyd/acrylic ratio of 4.8/95.2 weight %, since the total weight of alkyd and acrylic is equal to 5 (alkyd)+100 (acrylic)=105 (total). This conversion method may be used to convert any wt. % value given in the application to its corresponding phr value. Any wt. % value given should be understood to be equivalent to its corresponding phr value.

Throughout this application, where publications are referenced, the disclosures of these publications in their entireties are incorporated by reference into this application, in order to more fully describe the state of the art to which this invention pertains.

This invention can be further illustrated by the following examples of preferred embodiments thereof, although it will be understood that these examples are included merely for purposes of illustration and are not intended to limit the scope of the invention unless otherwise specifically indicated.

### EXAMPLES

### Example 1

### Preparation of an NPG/SIP Adduct

To a 3-L three-neck, round-bottom flask equipped with a mechanical stirrer, a steam-jacketed partial condenser, a Dean-Stark trap, a water condenser, and a nitrogen inlet were charged neopentyl glycol (NPG) 827.0 g (7.95 mole), 5-SSIPA 535.6 g (2.00 mole), Fascat 4100 (1.1 g), and water 91.9 g. The mixture was allowed to react at 140-190° C. and the distillate collected. The reaction was continued until an acid number of 2.3 mg KOH/g was obtained. The resulting adduct was cooled to 120° C. and isolated neat. Water may also be added to yield an adduct having 90% solids.

### Example 2

### Preparation of SSIPA Alkyd 1

To a 500 mL three-neck, round-bottom flask equipped with a mechanical stirrer, a steam-jacketed partial condenser, a Dean-Stark trap, a water condenser, and a nitrogen inlet were charged pentaerythritol (PE) 21.52 g (0.16 mole), trimethylolpropane (TMP) 69.74 g (0.52 mole), the NPG/SIP adduct of Example 1 (90% in water) 164.00 g, isophthalic acid (IPA) 123.25 g (0.74 mole), maleic anhydride (MA) 11.36 g (0.12 mole), Pamolyn 200 (generic name, available from Eastman Chemical Company, Kingsport, Tenn.) 259.38 g (0.89 mole), and Fascat 4100 0.46 g. The reaction temperature was gradually raised to 150° C. in 30 min. and the water distillate collected (12 mL). The reaction was allowed to continue at 170° C. for 30 min., 200 C for 30 min., and 228° C. for two hours until an acid number of 15 mg KOH/g was obtained (condensate 65 mL). The resulting viscous resin was allowed to cool to 150° C. and slowly poured into 500 g of stirred water. The mixing was allowed to continue at 80-90° C. for one hour to give an aqueous dispersion having 45.5% solids. The molecular weight of the resin was determined to be Mn 2,001 and Mw 117,072. The average particle size was determined to be 16 nm (about 70%) and 93 nm (about 30%).

### Example 3

### Preparation of Latex 1 Based on SSIPA Alkyd 1

Example 3 illustrates the preparation of an aqueous latex dispersion using 5 phr (parts per hundred of the ethylenically unsaturated monomers) SSIPA Alkyd 1 as the seed for emulsion polymerization. (Alkyd/Acrylic=4.8/95.2 weight %). The SSIPA alkyd used was a scaled-up batch of Example 2 having 48% solids. The calculated overall Tg of the acrylic monomers is 30° C.

To a 1-L water-jacketed kettle equipped with a mechanical stirrer, a water condenser, a nitrogen inlet, and reactant feeding tubes were added SSIPA Alkyd 1 dispersion (from Example 2,48% solids) 36.82 g and water 445.26 g. Separately, three solutions were prepared in the flasks-1) an initiator solution of ammonium persulfate 0.80 g, ammonium carbonate 0.88 g, and water 24.01 g, 2) a kicker solution of ammonium persulfate 0.80 g and water 11.64 g, and 3) a monomer mixture of methyl methacrylate 191.61 g, n-butyl acrylate 154.84 g, methacrylic acid 7.07 g, and a chain transfer agent, isooctyl 3-mercaptopropionate (IOMP), 1.77 g. The reaction mixture in the kettle was heated to 85° C. and the kicker added. The initiator solution and the monomer mixture were then simultaneously fed into the reaction kettle over 210 min. After the feeding was complete, the reaction mixture was allowed to cool to 60° C., during which time, three solutions were prepared to be used as the chaser: 1)oxidant: t-butyl hydroperoxide (tBHP) 1.27 g and water 10.02 g, 2) reductant: sodium formaldehyde sulfoxylate (SFS) 1.27 g and water 10.02 g, and 3) catalyst: ammonium iron (II) sulfate (1% in water) 1.27 g and ethylenediamine tetraacetic acid disodium salt dihydrate (EDTA, 1% in water) 0.64 g. The catalyst solution was then added all at once, while the oxidant and the reductant solutions were added in three portions every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size (PS) determined. % Solids: 42.2%; PS: 88 nm.

The following example illustrates the preparation of an aqueous latex dispersion using 5 phr of the SSIPA alkyd as the seed and a monomer pre-emulsion for emulsion polymerization. The calculated overall Tg of the acrylic monomers is 30° C.

### Example 4

### Preparation of Latex 2 Based on SSIPA Alkyd 1

To a 1-L water-jacketed kettle equipped with a mechanical stirrer, a water condenser, a nitrogen inlet, and reactant feeding tubes were added SSIPA Alkyd 1 dispersion (Example 2, 48%) 36.65 g and water 245.45 g. Separately, three solutions were prepared in the flasks-1) an initiator solution of ammonium persulfate 0.79 g, ammonium carbonate 0.88 g, and water 24.01 g, 2) a kicker solution of ammonium persulfate 0.79 g and water 11.64 g, and 3) a monomer pre-emulsion of methyl methacrylate 190.71 g, n-butyl acrylate 154.12 g, methacrylic acid 7.04 g, the surfactant, DISPONIL FES 993 (30%, available from Cognis Corp., Ambler, Pa.) 5.86 g, water 195.80 g, and the chain transfer agent, IOMP, 1.76 g. The reaction mixture in the kettle was heated to 85° C. and the kicker added. The initiator solution and the monomer pre-emulsion were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.27 g and water 10.02 g, 2) reductant: sodium formaldehyde sulfoxylate (SFS) 1.27 g and water 10.02 g, and 3) catalyst: ammonium iron (II) sulfate (1% in water) 1.27 g and EDTA (1% in water) 0.64 g. The catalyst solution was then added all at once, while the oxidant and the reductant solutions were added in three portions every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.2%; PS: 107 nm.

### Example 5

### Preparation of Latex 3 Based on 3.5 phr SSIPA Alkyd 1

Example 5 illustrates the preparation of aqueous latex dispersions, Latexes 3, 4 and 5, using 3.5 phr (Alkyd/Acrylic=3.4/96.6 weight %), 5.0 phr (Alkyd/Acrylic=4.8/95.2 weight %), and 7.5 phr (Alkyd/Acrylic=7/93 weight %), respectively, of the SSIPA Alkyd 1 as the seed, and a monomer pre-emulsion for emulsion polymerization. The calculated overall Tg of the acrylic monomers is 30° C.

To a 1-L water-jacketed kettle equipped with a mechanical stirrer, a water condenser, a nitrogen inlet, and reactant feeding tubes were added SSIPA Alkyd 1 dispersion (Example 2, 48% solids) 26.24 g and water 288.87 g. Separately, three solutions were prepared in the flasks: 1) an initiator solution of ammonium persulfate 0.80 g, ammonium carbonate 0.89 g, and water 24.01 g, 2) a kicker solution of ammonium persulfate 0.80 g and water 11.64 g, and 3) a monomer pre-emulsion of methyl methacrylate 193.36 g, n-butyl acrylate 156.26 g, methacrylic acid 7.14 g, the surfactant, AEROSOL TR 70 (70%, available from CYTEC Industries, West Paterson, N.J.), 1.78 g, water 161.88 g, and the chain transfer agent, IOMP, 1.78 g. The reaction mixture in the kettle was heated to 85° C. and the kicker added. The initiator solution and the monomer pre-emulsion were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.28 g and water 10.02 g, 2) reductant: d-isoascorbic acid (IAA) 1.28 g and water 10.02 g, and 3) catalyst: ammonium iron (II) sulfate (1% in water) 1.28 g and EDTA (1% in water) 0.64 g. The catalyst solution was then added all at once, while the oxidant and the reductant solutions were added over one hour at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.0%; PS: 98 nm; Residual monomers: 11 ppm.

By following the above procedure, Latexes 4 and 5 were prepared using, respectively, 5.0 and 7.5 phr of the SSIPA Alkyd 1, and their particle sizes determined. Latex 4: 100 nm; Latex 5: 84 nm.

Examples 6, 7, and 8 illustrate the preparation of aqueous latex dispersions using one-stage (homogeneous), two-stage (core-shell), and power feed (gradient) methods, respectively, and 5 phr SSIPA alkyd for emulsion polymerization. The calculated overall Tg of the acrylic monomers is 30° C.

### Example 6

### Preparation of Latex 6 Based on SSIPA Alkyd 1

To a 1-L water-jacketed kettle equipped with a mechanical stirrer, a water condenser, a nitrogen inlet, and reactant feeding tubes were added SSIPA Alkyd 1 dispersion (Example 2, 48% solids) 36.82 g and water 445.26 g. Separately, three solutions were prepared in the flasks: 1) an initiator solution of ammonium persulfate 0.80 g, ammonium carbonate 0.88 g, and water 24.01 g, 2) a kicker solution of ammonium persulfate 0.80 g and water 11.64 g, and 3) a monomer mixture of methyl methacrylate 191.61 g, n-butyl acrylate 154.84 g, methacrylic acid 7.07 g, and the chain transfer agent, IOMP, 1.77 g.

The reaction mixture in the kettle was heated to 85° C. and the kicker added. The initiator solution and the monomer pre-emulsion were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.27 g and water 10.02 g, 2) reductant: d-isoascorbic acid (IAA) 1.207 g and water 10.02 g, and 3) catalyst: ammonium iron (II) sulfate (1% in water) 1.27 g and EDTA (1% in water) 0.64 g. The catalyst solution was then added all at once, while the oxidant and the reductant solutions were added over one hour at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.2%; PS: 97 nm; Residual monomers: 4 ppm. Gloss of the clear film cast from the latex: 60°/20°=88/62.

### Example 7

### Preparation of Latex 7 Based on SSIPA Alkyd 1 (Two-Stage)

To a 1-L water-jacketed kettle equipped with a mechanical stirrer, a water condenser, a nitrogen inlet, and reactant feeding tubes were added SSIPA Alkyd 1 dispersion (Example 2, 48% solids) 36.82 g and water 445.26 g. Separately, four solutions were prepared in the flasks: 1) an initiator solution of ammonium persulfate 0.80 g, ammonium carbonate 0.88 g, and water 24.01 g, 2) a kicker solution of ammonium persulfate 0.80 g and water 11.64 g, 3) the first monomer mixture of methyl methacrylate 115.81 g, n-butyl acrylate 29.70 g, methacrylic acid 2.97 g, and the chain transfer agent, IOMP, 0.74 g, and 4) the second monomer mixture of methyl methacrylate 75.86 g, n-butyl acrylate 125.07 g, methacrylic acid 4.10 g, and the chain transfer agent, IOMP, 1.03 g.

The reaction mixture in the kettle was heated to 85° C. and the kicker added. The initiator solution and the first monomer mixture were then simultaneously fed into the reaction kettle. The feed rates were set up such that the initiator feed would last 210 min. and the first monomer mixture feed 117 min. The second monomer mixture was fed over 93 min. following the completion of the first monomer mixture feed. After the initiator and the monomer feeds were complete, the reaction mixture was allowed to cool to 60° C., during which time, three solutions were prepared to be used as the chaser: 1) oxidant: t-butyl hydroperoxide (tBHP) 1.27 g and water 10.02 g, 2) reductant: d-isoascorbic acid (IAA) 1.27 g and water 10.02 g, and 3) catalyst: ammonium iron (II) sulfate (1% in water) 1.27 g and EDTA (1% in water) 0.64 g. The catalyst solution was then added all at once, while the oxidant and the reductant solutions were added over one hour at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.8%; PS: 91 nm; Gloss of the clear film cast from the latex: 60°/20°=83/54.

### Example 8

### Preparation of Latex 8 Based on SSIPA Alkyd 1 (Power Feed)

To a 1-L water-jacketed kettle equipped with a mechanical stirrer, a water condenser, a nitrogen inlet, and reactant feeding tubes were added SSIPA Alkyd 1 dispersion (Example 2, 48% solids) 36.65 g and water 285.69 g. Separately, four solutions were prepared in the flasks: 1) an initiator solution of ammonium persulfate 0.79 g, ammonium carbonate 0.88 g, and water 24.01 g, 2) a kicker solution of ammonium persulfate 0.79 g and water 11.64 g, 3) the first monomer pre-emulsion of methyl methacrylate 115.27 g, n-butyl acrylate 29.56 g, methacrylic acid 2.96 g, a surfactant, TR 70, 1.06 g, water 66.74 g, and a chain transfer agent, IOMP, 0.74 g, and 4) the second monomer pre-emulsion of methyl methacrylate 75.51 g, n-butyl acrylate 124.49 g, methacrylic acid 4.08 g, a surfactant, TR 70, 1.46 g, water 92.17 g, and a chain transfer agent, IOMP, 1.02 g.

The reaction was set up in such a way that the second monomer pre-emulsion was fed into the stirred first monomer pre-emulsion, which was simultaneously fed into the kettle. This combined monomer feed, the second monomer feed, and the initiator feed were started at the same time after the reaction mixture in the kettle was heated to 85° C. and the kicker added. The feed time for each feed was set up to be 210 min. Following the completion of the additions, the reaction mixture was allowed to cool to 60° C., during which time, three solutions were prepared to be used as the chaser: 1) oxidant: t-butyl hydroperoxide (tBHP) 1.27 g and water 10.02 g, 2) reductant: d-isoascorbic acid (IAA) 1.27 g and water 10.02 g, and 3) catalyst: ammonium iron (II) sulfate (1% in water) 1.27 g and EDTA (1% in water) 0.63 g. The catalyst solution was then added all at once, while the oxidant and the reductant solutions were added over one hour at 60-40° C. After the chaser additions were complete, the reaction was allowed to continue for 30 min., and subsequently terminated by lowering the temperature to room temperature. The resulting emulsion was then filtered through a 100-mesh wire screen, and its % solids and particle size determined. % Solids: 42.1%; PS: 86 nm

### Example 9

### Preparation of SSIPA Alkyd 2 Based on Saturated Fatty Acid

To a 500 mL three-neck, round-bottom flask equipped with a mechanical stirrer, a steam-jacketed partial condenser, a Dean-Stark trap, a water condenser, and a nitrogen inlet were charged neopentyl glycol (NPG) 41.88 g (0.40 mole), trimethylolpropane (TMP) 48.66 g (0.36 mole), NPG/SIP adduct (90% in water) 78.50 g, phthalic anhydride (PA) 79.92 g (0.54 mole), maleic anhydride (MA) 20.76 g (0.21 mole), coconut oil fatty acid 100.00 g (0.48 mole), and Fascat 4100 0.18 g. The reaction temperature was gradually raised to 130° C. in 60 min. and the water distillate collected (12 mL). The reaction was allowed to continue at 170° C. for 45 min., 200° C. for 45 min., and 225° C. for three hours until an acid number of 8 mgKOH/g was obtained (condensate 30.5 mL). The resulting viscous resin was allowed to cool to 80° C. and water (270 g) added dropwise over one hour to give an aqueous dispersion having 55.3% solids. The molecular weight of the resin was determined to be Mn 823 and Mw 2,153. The average particle size was determined to be 13 nm (about 25%) and 39 nm (about 75%).

### Example 10

### Preparation of Latex 9 Based on SSIPA Alkyd 2

Example 10 illustrates the preparation of an aqueous latex dispersion using 5 phr of the SSIPA Alkyd 2 (of Example 9) based on saturated fatty acid as the seed for emulsion polymerization. The calculated overall Tg of the acrylic monomers is 25° C.

To a 1-L water-jacketed kettle equipped with a mechanical stirrer, a water condenser, a nitrogen inlet, and reactant feeding tubes were added the Alkyd 2 dispersion (of Example 9, 55.3%) 31.96 g and water 450.12 g. Separately, three solutions were prepared in the flasks: 1) an initiator solution of ammonium persulfate 0.80 g, ammonium carbonate 0.88 g, and water 24.01 g, 2) a kicker solution of ammonium persulfate 0.80 g and water 11.64 g, and 3) a monomer mixture of methyl methacrylate 181.71 g, n-butyl acrylate 164.74 g, methacrylic acid 7.07 g, and the chain transfer agent, IOMP, 1.77 g. The reaction mixture in the kettle was heated to 85° C. and the kicker added. The initiator solution and the monomer mixture were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.27 g and water 10.02 g, 2) reductant: sodium formaldehyde sulfoxylate (SFS) 1.27 g and water 10.02 g, and 3) catalyst: ammonium iron (II) sulfate (1% in water) 1.27 g and EDTA (1% in water) 0.64 g. The catalyst solution was then added all at once, while the oxidant and the reductant solutions were added in three portions every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.5%; PS: 104 nm. Gloss of the clear film cast from the latex: 60°/20°=88/70; Pendulum hardness: 40-45.

By using the same method and composition, a latex having 50% solids was successfully prepared as well; it showed PS 110 nm.

### Example 11

### Preparation of Latex 10 Based on SSIPA Alkyd 2

Example 11 illustrates the preparation of an aqueous latex dispersion using 10 phr of the SSIPA Alkyd s based on saturated fatty acid as the seed for emulsion polymerization. The calculated overall Tg of the acrylic monomers is 25° C.

To a 1-L water-jacketed kettle equipped with a mechanical stirrer, a water condenser, a nitrogen inlet, and reactant feeding tubes were added the SSIPA Alkyd 2 dispersion (from Example 9, 55.3% solids) 61.07 g and water 437.20 g. Separately, three solutions were prepared in the flasks: 1) an initiator solution of ammonium persulfate 0.76 g, ammonium carbonate 0.84 g, and water 24.01 g, 2) a kicker solution of ammonium persulfate 0.76 g and water 11.64 g, and 3) a monomer mixture of methyl methacrylate 173.59 g, n-butyl acrylate 157.38 g, methacrylic acid 6.75 g, and the chain transfer agent, IOMP, 1:69 g. The reaction mixture in the kettle was heated to 85° C. and the kicker added. The initiator solution and the monomer mixture were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.27 g and water 10.02 g, 2) reductant: sodium formaldehyde sulfoxylate (SFS) 1.27 g and water 10.02 g, and 3) catalyst: ammonium iron (II) sulfate (1% in water) 1.27 g and EDTA (1% in water) 0.64 g. The catalyst solution was then added all at once, while the oxidant and the reductant solutions were added in three portions every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.2%; PS: 90 nm. Gloss of the clear film cast from the latex: 60°/20°=89/72; residual monomers: 6 ppm.

### Example 12

### Preparation of Latex 11 Based on SSIPA Alkyd 2

Example 12 illustrates the preparation of an aqueous latex dispersion using 5 phr of the SSIPA Alkyd 2 based on saturated fatty acid as the seed and a monomer pre-emulsion for emulsion polymerization. The calculated overall Tg of the acrylic monomers is 30° C.

To a 1-L water-jacketed kettle equipped with a mechanical stirrer, a water condenser, a nitrogen inlet, and reactant feeding tubes were added the SSIPA Alkyd 2 dispersion (from Example 9, 55.3% solids) 31.81 g and water 290.53 g. Separately, three solutions were prepared in the flasks: 1) an initiator solution of ammonium persulfate 0.79 g, ammonium carbonate 0.88 g, and water 24.01 g, 2) a kicker solution of ammonium persulfate 0.79 g and water 11.64 g, and 3) a monomer pre-emulsion of methyl methacrylate 190.71 g, n-butyl acrylate 154.12 g, methacrylic acid 7.04 g, the surfactant, TR 70, 1.76 g, water 159.67 g, and the chain transfer agent, IOMP, 1.76 g.

The reaction mixture in the kettle was heated to 85° C. and the kicker added. The initiator solution and the monomer pre-emulsion were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.27 g and water 10.02 g, 2) reductant: sodium formaldehyde sulfoxylate (SFS) 1.27 g and water 10.02 g, and 3) catalyst: ammonium iron (II) sulfate (1% in water) 1.27 g and EDTA (1% in water) 0.64 g. The catalyst solution was then added all at once, while the oxidant and the reductant solutions were added in three portions every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.0%; PS: 108 nm. Gloss of the clear film cast from the latex: 60°/20°=88/70. Pendulum hardness: 60-65.

### Example 13

### Preparation of Latex 12 Based on SSIPA Alkyd 2

Example 13 illustrates the preparation of an aqueous latex dispersion using 10 phr of the SSIPA Alkyd 2 based on saturated fatty acid as the seed and a monomer pre-emulsion for emulsion polymerization. The calculated overall Tg of the acrylic monomers is 30° C.

To a 1-L water-jacketed kettle equipped with a mechanical stirrer, a water condenser, a nitrogen inlet, and reactant feeding tubes were added the Alkyd 2 dispersion (from Example 9, 55.3% solids) 60.80 g and water 284.76 g. Separately, three solutions were prepared in the flasks: 1) an initiator solution of ammonium persulfate 0.76 g, ammonium carbonate 0.84 g, and water 24.01 g, 2) a kicker solution of ammonium persulfate 0.76 g and water 11.64 g, and 3) a monomer pre-emulsion of methyl methacrylate 182.23 g, n-butyl acrylate 147.27 g, methacrylic acid 6.72 g, the surfactant, TR 70, 1.68 g, water 152.57 g, and the chain transfer agent, IOMP, 1.68 g.

The reaction mixture in the kettle was heated to 85° C. and the kicker added. The initiator solution and the monomer pre-emulsion were then simultaneously fed into the reaction kettle over 210 min. After the feeding was complete, the reaction mixture was allowed to cool to 60° C. During which time, three solutions were prepared to be used as the chaser: 1) oxidant: t-butyl hydroperoxide (tBHP) 1.27 g and water 10.02 g, 2) reductant: sodium formaldehyde sulfoxylate (SFS) 1.27 g and water 10.02 g, and 3) catalyst: ammonium iron (II) sulfate (1% in water) 1.27 g and EDTA (1% in water) 0.64 g. The catalyst solution was then added all at once, while the oxidant and the reductant solutions were added in three portions every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.2%; PS: 96 nm

### Example 14

### Preparation of Latex 13 Based on SSIPA Alkyd 2

Example 14 illustrates the preparation of an aqueous latex dispersion using 5 phr of the SSIPA Alkyd 2 based on saturated fatty acid as the seed for emulsion polymerization. The calculated overall Tg of the acrylic monomers is 30° C.

To a 1-L water-jacketed kettle equipped with a mechanical stirrer, a water condenser, a nitrogen inlet, and reactant feeding tubes were added the SSIPA Alkyd 2 dispersion (from Example 9, 55.3%) 31.96 g and water 450.12 g. Separately, three solutions were prepared in the flasks: 1) an initiator solution of ammonium persulfate 0.80 g, ammonium carbonate 0.88 g, and water 24.01 g, 2) a kicker solution of ammonium persulfate 0.80 g and water 11.64 g, and 3) a monomer mixture of methyl methacrylate 191.61 g, n-butyl acrylate 154.84 g, methacrylic acid 7.07 g, and the chain transfer agent, IOMP, 1.77 g.

The reaction mixture in the kettle was heated to 85° C. and the kicker added. The initiator solution and the monomer mixture were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.27 g and water 10.02 g, 2) reductant: sodium formaldehyde sulfoxylate (SFS), 1.27 g and water 10.02 g, and 3) catalyst: ammonium iron (II) sulfate (1% in water) 1.27 g and EDTA (1% in water) 0.64 g. The catalyst solution was then added all at once, while the oxidant and the reductant solutions were added in three portions every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 41.8%; PS: 109 nm

### Example 15

### Preparation of Latex 14 Based on SSIPA Alkyd 2

Example 15 illustrates the preparation of an aqueous latex dispersion using 10 phr of the SSIPA Alkyd 2 based on saturated fatty acid as the seed for emulsion polymerization. The calculated overall Tg of the acrylic monomers is 30° C.

To a 1-L water-jacketed kettle equipped with a mechanical stirrer, a water condenser, a nitrogen inlet, and reactant feeding tubes were added the SSIPA Alkyd 2 dispersion (from Example 9, 50% solids) 67.54 g and water 430.72 g. Separately, three solutions were prepared in the flasks: 1) an initiator solution of ammonium persulfate 0.76 g, ammonium carbonate 0.84 g, and water 24.01 g, 2) a kicker solution of ammonium persulfate 0.76 g and water 11.64 g, and 3) a monomer mixture of methyl methacrylate 183.05 g, n-butyl acrylate 147.92 g, methacrylic acid 6.75 g, and the chain transfer agent, IOMP, 1.69 g.

The reaction mixture in the kettle was heated to 85° C. and the kicker added. The initiator solution and the monomer mixture were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.22 g and water 10.02 g, 2) reductant: sodium formaldehyde sulfoxylate (SFS) 1.22 g and water 10.02 g, and 3) catalyst: ammonium iron (II) sulfate (1% in water) 1.22 g and EDTA (1% in water) 0.61 g. The catalyst solution was then added all at once, while the oxidant and the reductant solutions were added in three portions every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.4%; PS: 99 nm

### Example 16

### Preparation of Latex 15 Based on SSIPA Alkyd 2

Example 16 illustrates the preparation of an aqueous latex dispersion using 5 phr of the SSIPA Alkyd 2 based on saturated fatty acid as the seed for emulsion polymerization. The calculated overall Tg of the acrylic monomers is 35° C.

To a 1-L water-jacketed kettle equipped with a mechanical stirrer, a water condenser, a nitrogen inlet, and reactant feeding tubes were added the SSIPA Alkyd 2 dispersion (from Example 9, 55.3% solids) 31.96 g and water 450.12 g. Separately, three solutions were prepared in the flasks: 1) an initiator solution of ammonium persulfate 0.80 g, ammonium carbonate 0.88 g, and water 24.01 g, 2) a kicker solution of ammonium persulfate 0.80 g and water 11.64 g, and 3) a monomer mixture of methyl methacrylate 203.10 g, n-butyl acrylate 143.35 g, methacrylic acid 7.07 g, and the chain transfer agent, IOMP, 1.77 g.

The reaction mixture in the kettle was heated to 85° C. and the kicker added. The initiator solution and the monomer mixture were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.27 g and water 10.02 g, 2) reductant: sodium formaldehyde sulfoxylate (SFS) 1.27 g and water 10.02 g, and 3) catalyst: ammonium iron (II) sulfate (1% in water) 1.27 g and EDTA (1% in water) 0.64 g. The catalyst solution was then added all at once, while the oxidant and the reductant solutions were added in three portions every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.3%; PS: 119 nm (about 90%) and 46 nm (about 10%). The film cast from this latex was cracked.

### Example 17

### Preparation of Latex 16 Based on SSIPA Alkyd 2

Example 17 illustrates the preparation of an aqueous latex dispersion using 10 phr of the SSIPA Alkyd 2 based on saturated fatty acid as the seed for emulsion polymerization. The calculated overall Tg of the acrylic monomers is 35° C.

To a 1-L water-jacketed kettle equipped with a mechanical stirrer, a water condenser, a nitrogen inlet, and reactant feeding tubes were added the SSIPA Alkyd 2 dispersion (from Example 9, 55.3% solids) 61.07 g and water 437.20 g. Separately, three solutions were prepared in the flasks: 1) an initiator solution of ammonium persulfate 0.76 g, ammonium carbonate 0.84 g, and water 24.01 g, 2) a kicker solution of ammonium persulfate 0.76 g and water 11.64 g, and 3) a monomer mixture of methyl methacrylate 194.02 g, n-butyl acrylate 136.95 g, methacrylic acid 6.75 g, and the chain transfer agent, IOMP, 1.69 g.

The reaction mixture in the kettle was heated to 85° C. and the kicker added. The initiator solution and the monomer mixture were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.22 g and water 10.02 g, 2) reductant: sodium formaldehyde sulfoxylate (SFS) 1.22 g and water 10.02 g, and 3) catalyst: ammonium iron (II) sulfate (1% in water) 1.22 g and EDTA (1% in water) 0.61 g. The catalyst solution was then added all at once, while the oxidant and the reductant solutions were added in three portions, at 15 min. intervals at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 41.8%; PS: 103 nm (about 90%) and 40 nm (about 10%). The film cast from this latex was slightly cracked.

### Example 18

### Preparation of Latex 17 Based on SSIPA Alkyd 2

Example 18 illustrates the preparation of an aqueous latex dispersion using 15 phr (Alkyd/Acrylic=13/87 weight %) of the SSIPA Alkyd 2 based on saturated fatty acid as the seed for emulsion polymerization. The calculated overall Tg of the acrylic monomers is 35° C.

To a 1-L water-jacketed kettle equipped with a mechanical stirrer, a water condenser, a nitrogen inlet, and reactant feeding tubes were added the SSIPA Alkyd 2 dispersion (from Example 9, 55.3% solids) 87.69 g and water 425.38 g. Separately, three solutions were prepared in the flasks: 1) an initiator solution of ammonium persulfate 0.73 g, ammonium carbonate 0.81 g, and water 24.01 g, 2) a kicker solution of ammonium persulfate 0.73 g and water 11.64 g, and 3) a monomer mixture of methyl methacrylate 185.73 g, n-butyl acrylate 131.09 g, methacrylic acid 6.47 g, and the chain transfer agent, IOMP, 1.62 g.

The reaction mixture in the kettle was heated to 85° C. and the kicker added. The initiator solution and the monomer mixture were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.16 g and water 10.02 g, 2) reductant: sodium formaldehyde sulfoxylate (SFS) 1.16 g and water 10.02 g, and 3) catalyst: ammonium iron (II) sulfate (1% in water) 1.16 g and EDTA (1% in water) 0.58 g. The catalyst solution was then added all at once, while the oxidant and the reductant solutions were added in three portions, every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.3%; PS: 93 nm (about 90%) and 42 nm (about 10%).

### Example 19

### Preparation of Latex 18 Based on SSIPA Alkyd 2

Example 19 illustrates the preparation of an aqueous latex dispersion using 5 phr of the SSIPA Alkyd 2 based on saturated fatty acid as the seed for emulsion polymerization. The calculated overall Tg of the acrylic monomers is 30° C. This example also demonstrates the utilization of a lower ratio (0.1 phr) of IAA in the chaser as opposed to the amount (0.3 phr) used in Example 5-8. The latexes based on this ratio have been found to be non-yellowing over time. IAA is known to be capable of causing yellowness on latexes over time.

To a 1-L water-jacketed kettle equipped with a mechanical stirrer, a water condenser, a nitrogen inlet, and reactant feeding tubes were added the SSIPA Alkyd 2 dispersion (from Example 9, 50% solids) 35.52 g and water 444.76 g. Separately, three solutions were prepared in the flasks: 1) an initiator solution of ammonium persulfate 0.80 g, ammonium carbonate 0.88 g, and water 25.00 g, 2) a kicker solution of ammonium persulfate 0.80 g and water 12.53 g, and 3) a monomer mixture of methyl methacrylate 192.54 g, n-butyl acrylate 155.60 g, methacrylic acid 7.10 g, and the chain transfer agent, IOMP, 1.78 g.

The reaction mixture in the kettle was heated to 85° C. and the kicker added. The initiator solution and the monomer mixture were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 0.36 g and water 10.02 g, 2) reductant: d-isoascorbic acid (IAA) 0.36 g and water 10.02 g, and 3) catalyst: ammonium iron (II) sulfate (1% in water) 1.28 g and EDTA (1% in water) 0.64 g. The catalyst solution was then added all at once, while the oxidant and the reductant solutions were added in three portions every 15 min. at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.8%; PS: 111 nm; Residual monomers: 73 ppm.

### Example 20

### Preparation of Latex 19 Based on SSIPA Alkyd 2

Example 20 illustrates the preparation of an aqueous latex dispersion using 2 phr (Alkyd/Acrylic=1.96/98.04 weight %) of the SSIPA Alkyd 2 based on saturated fatty acid as the seed for emulsion polymerization. The calculated overall Tg of the acrylic monomers is 30° C.

To a 1-L water-jacketed kettle equipped with a mechanical stirrer, a water condenser, a nitrogen inlet, and reactant feeding tubes were added the SSIPA Alkyd 2 dispersion (from Example 9, 50% solids) 14.62 g and water 455.16 g. Separately, three solutions were prepared in the flasks: 1) an initiator solution of ammonium persulfate 0.82 g, ammonium carbonate 0.91 g, and water 25.00 g, 2) a kicker solution of ammonium persulfate 0.82 g and water 12.53 g, and 3) a monomer mixture of methyl methacrylate 198.13 g, n-butyl acrylate 160.11 g, methacrylic acid 7.31 g, and the chain transfer agent, IOMP, 1.83 g. The reaction mixture in the kettle was heated to 85° C. and the kicker added. The initiator solution and the monomer mixture were then simultaneously fed into the reaction kettle over 210 min. After the feeding was, complete, the reaction mixture was allowed to cool to 60° C., during which time, three solutions were prepared to be used as the chaser: 1) oxidant: t-butyl hydroperoxide (tBHP) 0.37 g and water 10.02 g, 2) reductant: d-isoascorbic acid (IAA) 0.37 g and water 10.02 g, and 3) catalyst: ammonium iron (II) sulfate (1% in water) 1.32 g and EDTA (1% in water) 0.66 g. The catalyst solution was then added all at once, while the oxidant and the reductant solutions were added in three portions, at 15 min. intervals, at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.9%; PS: 135 nm (about 85%) and 65 nm (about 15%).

### Example 21

### Preparation of Latex 20 Based on SSIPA Alkyd 2

Example 12 illustrates the preparation of an aqueous latex dispersion using phr of the SSIPA Alkyd 2 based on saturated fatty acid as the seed and a redox initiator system for emulsion polymerization. The calculated overall Tg of the acrylic monomers is 30° C.

To a 1-L water-jacketed kettle equipped with a mechanical stirrer, a water condenser, a nitrogen inlet, and reactant feeding tubes were added the SSIPA Alkyd 2 dispersion (from Example 9, 50% solids) 35.51 g and water 411.87 g. Separately, three solutions were prepared in the flasks: 1) an initiator solution (oxidant) of t-butyl hydroperoxide (tBHP, 70%) 1.01 g and water 25.00 g, 2) a reductant solution of d-isoascorbic acid (IAA) 0.71 g, ammonium carbonate 0.71 g, and water 25.00 g, and 3) a monomer mixture of methyl methacrylate 198.13 g, n-butyl acrylate 160.11 g, methacrylic acid 7.31 g, and the chain transfer agent, IOMP, 1.83 g. Additionally, a kicker consisting of three solutions was also prepared; they were (a) 0.25 g tBHP in 10.02 g water, (b) 0.18 g IAA and 0.18 g ammonium carbonate in 10.02 g water, and (c) 1.28 g ammonium iron (II) sulfate (1% in water) and 0.64 g EDTA (1% in water).

The reaction mixture in the kettle was heated to 65° C. and the kicker added. The initiator solution, the reductant solution, and the monomer mixture were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 0.36 g and water 10.02 g, 2) reductant: d-isoascorbic acid (IAA) 0.36 g and water 10.02 g, and 3) catalyst: ammonium iron (II) sulfate (1% in water) 1.28 g and EDTA (1% in water) 0.64 g. The catalyst solution was then added all at once, while the oxidant and the reductant solutions were added in three portions, at 15 min. intervals, at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.1%; PS: 123 nm. Residual monomers: 219 ppm.

### Example 22

### Preparation of Latex 21 Based on SSIPA Alkyd 2 (Two-Stage)

Example 22 illustrates the preparation of an aqueous latex dispersion using 5 phr of the SSIPA Alkyd 2 based on saturated fatty acid as the seed, and using a two-stage monomer feed method for emulsion polymerization. The calculated overall Tg of the acrylic monomers is 30° C.

To a 1-L water-jacketed kettle equipped with a mechanical stirrer, a water condenser, a nitrogen inlet, and reactant feeding tubes were added SSIPA Alkyd 2 dispersion (from Example 9, 50% solids) 35.52 g and water 444.76 g. Separately, four solutions were prepared in the flasks: 1) an initiator solution of ammonium persulfate 0.80 g, ammonium carbonate 0.89 g, and water 25.00 g, 2) a kicker solution of ammonium persulfate 0.80 g and water 12.53 g, 3) the first monomer mixture of methyl methacrylate 115.04 g, n-butyl acrylate 13.07 g, methacrylic acid 2.61 g, and the chain transfer agent, IOMP, 0.75 g, and 4) the second monomer mixture of methyl methacrylate 77.50 g, n-butyl acrylate 142.52 g, methacrylic acid 4.49 g, and the chain transfer agent, IOMP, 1.03 g.

The reaction mixture in the kettle was heated to 85° C. and the kicker added. The initiator solution and the first monomer mixture were then simultaneously fed into the reaction kettle. The feed rates were set up such that the initiator feed would last 210 min. and the first monomer mixture feed 117 min. The second monomer mixture was fed over 93 min., following the completion of the first monomer mixture feed. After the initiator and the monomer feeds were complete, the reaction mixture was allowed to cool to 60° C., during which time three solutions were prepared to be used as the chaser: 1) oxidant: t-butyl hydroperoxide (tBHP) 0.36 g and water 10.02 g, 2) reductant: d-isoascorbic acid (IAA) 0.36 g and water 10.02 g, and 3) catalyst: ammonium iron (II) sulfate (1% in water) 1.28 g and EDTA (1% in water) 0.64 g. The catalyst solution was then added all at once, while the oxidant and the reductant solutions were added in three portions, at 15 min. intervals, at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.0%; PS: 129 nm

### Comparative Example 1

### Preparation of Latex 22 Based on SSIPA Alkyd 1

Comparative Example 1 illustrates the preparation of an aqueous latex dispersion using 33.33 phr (alkyd/acrylic=25/75 weight %) of the SSIPA Alkyd 1 as the seed and a monomer pre-emulsion for emulsion polymerization. This comparative example shows that when a high ratio of the SSIPA alkyd is employed, the resultant latex has large particle sizes and high residual monomer content.

To a 1-L water-jacketed kettle equipped with a mechanical stirrer, a water condenser, a nitrogen inlet, and reactant feeding tubes were added the above SSIPA Alkyd 1 dispersion (from Example 2, 48% solids) 191.93 g and water 177.48 g. Separately, three solutions were prepared in the flasks: 1) an initiator solution of ammonium persulfate 0.62 g, ammonium carbonate 0.69 g, and water 25.06 g, 2) a kicker solution of ammonium persulfate 0.62 g and water 10.18 g, and 3) a monomer pre-emulsion of methyl methacrylate 90.11 g, 2-ethylhexyl acrylate 90.66 g, styrene 90.11 g, methacrylic acid 5.53 g, the surfactant, Hitenol BC 1025 (25%, available from Montello Inc, Tulsa, Okla.), 16.58 g, water 175.52 g, and the chain transfer agent, IOMP, 1.38 g.

The reaction mixture in the kettle was heated to 85° C. and the kicker added. The initiator solution and the monomer pre-emulsion were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.00 g and water 10.02 g, 2) reductant: d-isoascorbic acid (IAA) 1.00 g and water 10.02 g, and 3) catalyst: ammonium iron (II) sulfate (1% in water) 1.00 g and EDTA (1% in water) 0.50 g. The catalyst solution was then added all at once, while the oxidant and the reductant solutions were added, over one hour, at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.0%; PS: 545 nm (50%) and 58 nm (50%); Residual monomers 1657 ppm.

### Comparative Example 2

### Preparation of Latex 23 Without SSIPA Alkyd

Comparative Example 2 illustrates the preparation of an aqueous latex dispersion by feeding a monomer pre-emulsion to a reaction mixture without SSIPA alkyd for emulsion polymerization. This comparative example shows that when there are no SSIPA alkyd particles present to control the latex particle growth, the resultant latex has a very large particle size.

Water 296.87 g was added to a 1-L water-jacketed kettle equipped with a mechanical stirrer, a water condenser, a nitrogen inlet, and reactant feeding tubes. Separately, three solutions were prepared in the flasks: 1) an initiator solution of ammonium persulfate 0.83 g, ammonium carbonate 0.92 g, and water 24.01 g, 2) a kicker solution of ammonium persulfate 0.83 g and water 11.64 g, and 3) a monomer pre-emulsion of methyl methacrylate 200.02 g, n-butyl acrylate 161.64 g, methacrylic acid 7.38 g, the surfactant, TR 70, 1.85 g, water 167.46 g, and the chain transfer agent, IOMP, 1.85 g.

The reaction mixture in the kettle was heated to 85° C. and the kicker added. The initiator solution and the monomer pre-emulsion were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.33 g and water 10.02 g, 2) reductant: d-isoascorbic acid (IAA) 1.33 g and water 10.02 g, and 3) catalyst: ammonium iron (II) sulfate (1% in water) 1.33 g and EDTA (1% in water) 0.66 g. The catalyst solution was then added all at once, while the oxidant and the reductant solutions were added, over one hour, at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 43.2%; PS: 667 nm.

### Comparative Example 3

### Preparation of Latex 24 Using SSIPA Alkyd 1 as the Surfactant for Monomer Pre-Emulsion

Comparative Example 3 illustrates the preparation of an aqueous latex dispersion by first using 5 phr SSIPA Alkyd 1 (from Example 2, 48% solids) as the surfactant, to emulsify the monomers, and then using 5% of the resulting monomer pre-emulsion as the seed for emulsion polymerization. This is a typical method known in the art, wherein a monomer pre-emulsion is first prepared by using a surfactant. A small ratio (e.g. 5%) of the pre-emulsion is then used as the seed to control the latex particle growth. This comparative example demonstrates that when the SSIPA alkyd is used as a surfactant for such a method, rather than as a seed, a latex with small particles is not obtained.

A monomer pre-emulsion was prepared by sequentially adding n-butyl acrylate 154.84 g, methyl methacrylate 191.61 g, methacrylic acid 7.07 g, and the chain transfer agent, IOMP, 1.77 g to a stirred dispersion of 36.82 g SSIPA alkyd 1 (from Example 2, 48% solids) in 199.89 g water. A portion (29.60 g) of the resulting monomer pre-emulsion was charged to a 1-L water-jacketed kettle equipped with a mechanical stirrer, a water condenser, a nitrogen inlet, and reactant feeding tubes. Separately, two solutions were prepared in the flasks: 1) an initiator solution of ammonium persulfate 0.80 g, ammonium carbonate 0.88 g, and water 24.01 g, 2) a kicker solution of ammonium persulfate 0.80 g and water 11.64 g.

The reaction mixture in the kettle was heated to 85° C. and the kicker added. The initiator solution and the monomer mixture were then simultaneously fed into the reaction kettle over 210 min. After the feeding was complete, the reaction mixture was allowed to cool to 60° C., during which time, three solutions were prepared to be used as the chaser: 1) oxidant: t-butyl hydroperoxide (tBHP) 1.27 g and water 10.02 g, 2) reductant: d-isoascorbic acid (IAA) 1.27 g and water 10.02 g, and 3) catalyst: ammonium iron (II) sulfate (1% in water) 1.27 g and EDTA (1% in water) 0.64 g. The catalyst solution was then added all at once, while the oxidant and the reductant solutions were added in three portions, at 15 min. intervals, at 60-40° C. After the chaser additions were complete, the reaction was allowed to continue for 30 min. and subsequently terminated by lowering the temperature to room temperature. The resulting emulsion was then filtered through a 100-mesh wire screen, and its % solids and particle size determined. % Solids: 42.0%; PS: 297 nm (with two small peaks at 21 and 97 nm).

The invention has been described in detail with particular reference to preferred embodiments, but it will be understood that variations and modifications can be effected within the spirit and scope of the invention. Although specific terms are employed, they are used in a generic and descriptive sense only and not for purposes of limitation, the scope of the invention being set forth in the following claims.

1. An aqueous latex dispersion composition, comprising the emulsion polymerization reaction product of:
(a) about 2 to about 15 weight percent, based on the total weight of (a) and (b), of a sulfonated alkyd;
(b) about 85 to about 98 weight percent, based on the total weight of (a) and (b), of one or more ethylenically unsaturated monomers; and
(c) a catalytic amount of an initiator for free-radical emulsion polymerization,
wherein components (b) and (c) are fed into an aqueous dispersion of (a) during the emulsion polymerization process.

2. The aqueous latex dispersion composition according to claim 1, wherein the sulfonated alkyd comprises the polycondensation reaction product of:
i. about 10 to about 50 weight percent of one or more of: a glycol or a polyol,
ii. about 10 to about 80 weight percent of one or more of: a monobasic fatty acid, a monobasic fatty ester, a naturally occurring oil, or a partially-saponified oil,
iii. about 5 to about 40 weight percent of one or more of: a dicarboxylic acid or anhydride or a poly-carboxylic acid or anhydride, and
iv. about 5 to about 15 weight percent of one or more of: a sulfomonomer or a sulfomonomer adduct containing at least one sulfomonomer group, wherein the weight percent is based on the weight of the sulfomonomer,
wherein the weight percents of (i), (ii), (iii), and (iv) are based on the total weight of (i), (ii), (iii), and (iv).

3. The aqueous latex dispersion according to claim 1, wherein the average particle size of the aqueous latex dispersion obtained is from about 60 to about 140 nm.

4. The aqueous latex dispersion according to claim 1, wherein the average particle size of the aqueous latex dispersion obtained is from about 70 to about 130 nm.

5. The aqueous latex dispersion according to claim 1, wherein the average particle size of the aqueous latex dispersion obtained is less than about 140 nm.

6. The aqueous latex dispersion according to claim 1, wherein the average particle size of the aqueous latex dispersion obtained is less than about 130 nm.

7. The aqueous latex dispersion according to claim 1, wherein the average particle size of the aqueous latex dispersion obtained is less than 110 nm.

8. The aqueous latex dispersion according to claim 1, wherein the particle size of the aqueous dispersion of the waterborne alkyd is from about 15 to about 50 nm.

9. The aqueous latex dispersion according to claim 1, wherein the particle size of the aqueous dispersion of the waterborne alkyd is from about 20 to about 40 nm.

10. The aqueous latex dispersion according to claim 1, wherein the sulfonated alkyd is provided in an amount from about 3 to about 10 weight percent.

11. The aqueous latex dispersion according to claim 1, wherein the sulfonated alkyd is provided in an amount from about 5 to about 8 weight percent.

12. The aqueous latex dispersion according to claim 1, wherein the initiator comprises one or more of: hydrogen peroxide, a potassium peroxydisulfate, an ammonium peroxydisulfate, dibenzoyl peroxide, lauryl peroxide, ditertiary butyl peroxide, 2,2′-azobisisobutyronitrile, t-butyl hydroperoxide, or benzoyl peroxide.

13. The aqueous latex dispersion according to claim 1, wherein the one or more ethylenically unsaturated monomers comprise one or more of: styrene, α-methyl styrene, vinyl naphthalene, vinyl toluene, chloromethyl styrene, methyl acrylate, acrylic acid, methacrylic acid, methyl methacrylate, ethyl acrylate, ethyl methacrylate, butyl acrylate, butyl methacrylate, isobutyl acrylate, isobutyl methacrylate, ethylhexyl acrylate, ethylhexyl methacrylate, octyl acrylate, octyl methacrylate, glycidyl methacrylate, carbodiimide methacrylate, an alkyl crotonate, vinyl acetate, di-n-butyl maleate, di-octylmaleate, t-butylaminoethyl methacrylate, dimethylaminoethyl methacrylate, diethylaminoethyl methacrylate, N,N-dimethylaminopropyl methacrylamide, 2-t-butylaminoethyl methacrylate, N,N-dimethylaminoethyl acrylate, N-(2-methacryloyloxy-ethyl)ethylene urea, or methacrylamidoethylethylene urea.

14. A process for preparing an aqueous latex dispersion, comprising the steps of:
preparing an aqueous dispersion of a sulfonated alkyd to form seed particles; and
polymerizing one or more ethylenically unsaturated monomers, in the presence of the sulfonated alkyd resin seed particles, to obtain an aqueous latex dispersion,
wherein the sulfonated alkyd resin is provided in an amount from about 2-15 wt. %, based on the total weight of the sulfonated alkyd resin and the one or more ethylenically unsaturated monomer.

15. The process according to claim 14, wherein the sulfonated alkyd comprises the polycondensation reaction product of:
i. about 10 to about 50 weight percent of one or more of: a glycol or a polyol,
ii. about 10 to about 80 weight percent of one or more of: a monobasic fatty acid, a monobasic fatty ester, a naturally occurring oil, or a partially-saponified oil,
iii. about 5 to about 40 weight percent of one or more of: a di carboxylic acid or anhydride or a poly-carboxylic acid or anhydride, and
iv. about 5 to about 15 weight percent of one or more of: a sulfomonomer or a sulfomonomer adduct containing at least one sulfomonomer group, wherein the weight percent is based on the weight of the sulfomonomer,
wherein the weight percents of (i), (ii), (iii), and (iv) are based on the total weight of (i), (ii), (iii), and (iv).

16. The process according to claim 14, wherein the average particle size of the aqueous latex dispersion obtained is from about 60 to about 140 nm.

17. The process according to claim 14, wherein the average particle size of the aqueous latex dispersion obtained is from about 70 to about 130 nm.

18. The process according to claim 14, wherein the average particle size of the aqueous latex dispersion obtained is less than about 140 nm.

19. The process according to claim 14, wherein the average particle size of the aqueous latex dispersion obtained is less than about 130 nm.

20. The process according to claim 14, wherein the average particle size of the aqueous latex dispersion obtained is less than 110 nm.

21. The process according to claim 14, wherein the particle size of the sulfonated alkyd seed particles is from about 15 to about 50 nm.

22. The process according to claim 14, wherein the particle size of the sulfonated alkyd seed particles is from about 20 to about 40 nm.

23. The process according to claim 14, wherein the sulfonated alkyd is provided in an amount from about 3 to about 10 weight percent.

24. The process according to claim 1, wherein the sulfonated alkyd is provided in an amount from about 5 to about 8 weight percent.

25. The process according to claim 14, wherein the polymerizing is carried out in the presence of an initiator comprising one or more of: hydrogen peroxide, a potassium peroxydisulfate, an ammonium peroxydisulfate, dibenzoyl peroxide, lauryl peroxide, ditertiary butyl peroxide, 2,2′-azobisisobutyronitrile, t-butyl hydroperoxide, or benzoyl peroxide.

26. The process according to claim 14, wherein the one or more ethylenically unsaturated monomers comprise one or more of: styrene, α-methyl styrene, vinyl naphthalene, vinyl toluene, chloromethyl styrene, methyl acrylate, acrylic acid, methacrylic acid, methyl methacrylate, ethyl acrylate, ethyl methacrylate, butyl acrylate, butyl methacrylate, isobutyl acrylate, isobutyl methacrylate, ethylhexyl acrylate, ethylhexyl methacrylate, octyl acrylate, octyl methacrylate, glycidyl methacrylate, carbodiimide methacrylate, an alkyl crotonate, vinyl acetate, di-n-butyl maleate, di-octylmaleate, t-butylaminoethyl methacrylate, dimethylaminoethyl methacrylate, diethylaminoethyl methacrylate, N,N-dimethylaminopropyl methacrylamide, 2-t-butylaminoethyl methacrylate, N,N-dimethylaminoethyl acrylate, N-(2-methacryloyloxy-ethyl)ethylene urea, or methacrylamidoethylethylene urea.

27. In a process for producing an aqueous latex dispersion via emulsion polymerization of at least one ethylenically unsaturated monomer, the improvement comprising:
carrying out the emulsion polymerization process in the presence of sulfonated alkyd seed particles provided in an amount from about 2 to about 15 weight, with respect to the total weight of the latex polymer obtained.

28. The aqueous latex dispersion prepared by the process according to claim 14.

29. A coated article, prepared by applying the aqueous latex dispersion of claim 1 to an article, and drying the coating composition.

30. A coating composition, comprising the aqueous latex dispersion according to claim 1.

31. The coating composition according to claim 30, further comprising one or more fillers and/or pigments.

32. An article coated with the coating composition of claim 31.

33. The article according to claim 32, wherein the article is a member selected from the group consisting of wood, wood by-products, gypsum board, metal, plastic, concrete, a textile product, leather, and masonry.
